(19) United States
(12) Patent Application Publication
(10) Pub. No.: US 2026/0234055 A1
(43) Pub. Date: Aug. 13, 2026

(54) COMPOSITIONS, METHODS, AND SYSTEMS RELATED TO TRANSFORMATION OF VATERITE PARTICLES

(71) Applicant: Arelac, Inc., San Jose, CA (US)

(72) Inventors: Ryan J. Gilliam, San Jose, CA (US); Sarah Granke, San Jose, CA (US); Jacqueline A. Whitham, Campbell, CA (US)

(21) Appl. No.: 19/153,578

(22) PCT Filed: Feb. 6, 2024
(86) PCT No.: PCT/US2024/014607

§ 371 Date: Aug. 4, 2025

Related U.S. Application Data
(60) Provisional application No. 63/443,808, filed on Feb. 7, 2023.

(51) Int. Cl. C04B 20/10; C04B 14/28; C04B 20/04; C09C 1/02; C09C 3/04; C09C 3/06

(52) U.S. Cl. CPC C04B 20/107; C04B 14/28; C04B 20/04; C09C 1/024; C09C 3/043; C09C 3/063; C01P 2002/76; C01P 2004/03; C01P 2004/32; C01P 2004/61; C01P 2004/84; C01P 2006/12

(57) ABSTRACT

Embodiments relate to compositions, methods, and systems related to polymorph compositions comprising needle shaped aragonite particles on the surface of the vaterite particles. Some embodiments relate to systems for the formation of aragonite particles on the surface of the vaterite particles utilizing a calcining reactor, a dissolution reactor, a treatment reactor, and a transforming station, for partially transforming the vaterite particles into aragonite particles and forming a calcium carbonate polymorph composition comprising vaterite particles and aragonite particles, wherein the aragonite particles are formed on surface of the vaterite particles.

### CROSS-REFERENCE TO RELATED APPLICATION

This application claims the benefit of priority to U.S. Provisional Patent Application Ser. No. 63/443,808 entitled “COMPOSITIONS, METHODS, AND SYSTEMS RELATED TO TRANSFORMATION OF VATERITE PARTICLES,” filed Feb. 7, 2023, the disclosure of which is incorporated herein in its entirety by reference.

### BACKGROUND

Cement is a binding chemical substance used for construction that sets, hardens, and adheres to other materials to bind them together. Concrete may be the second most consumed product on earth behind water and cement production may account for about 8% of global CO₂ production. Cement materials may be classified into two distinct categories: hydraulic cements and non-hydraulic cements according to their respective setting and hardening mechanisms. The hydraulic cement setting and hardening may involve hydration reactions and therefore may require water, while non-hydraulic cements may only react with a gas and may directly set under air. There is a need associated with the production of cement and concrete without compromising on the strength and durability of the product.

### SUMMARY

Some embodiments relate to a calcium carbonate polymorph composition, including: vaterite particles and aragonite particles, wherein the aragonite particles are formed on the surface of the vaterite particles.

Some embodiments relate to a calcium carbonate polymorph composition, wherein the vaterite particles are significantly spherical.

Some embodiments relate to a calcium carbonate polymorph composition, wherein the aragonite particles radiate out from the surface of the vaterite particles.

Some embodiments relate to a calcium carbonate polymorph composition, wherein the vaterite particles and the aragonite particles have an average particle size of between 0.1-150 μm.

Some embodiments relate to a calcium carbonate polymorph composition, the aragonite particles are between 5-90% by weight of the calcium carbonate polymorph composition.

Some embodiments relate to a calcium carbonate polymorph composition, wherein the aragonite particles accelerate transformation of the vaterite particles to more aragonite particle when coming into contact with water.

Some embodiments relate to a calcium carbonate polymorph composition, wherein the aragonite particles accelerate setting and hardening of the calcium carbonate polymorph composition.

Some embodiments relate to a calcium carbonate polymorph composition, wherein the vaterite particles have a specific surface area of between 200-40,000 m2/kg and the aragonite particles have a specific surface area of between 200-20,000 m2/kg.

Some embodiments relate to a calcium carbonate polymorph composition, further including calcite particles which are less than 5% by weight of the calcium carbonate polymorph composition.

Some embodiments relate to a calcium carbonate polymorph composition, wherein the composition further includes one or more other components selected from a group consisting of limestone, aluminosilicate material, aggregate, slag from metal production, Portland cement clinker, calcium aluminate cement clinker, calcium sulfoaluminate cement clinker, carbonate material, alkali metal accelerator, an alkaline earth metal accelerator, admixture, additive, SCM, and combination thereof.

Some embodiments relate to a method of producing a calcium carbonate polymorph composition, including: forming a wet composition including vaterite particles; transforming the wet composition including vaterite particles under one or more transforming conditions to partially transform the vaterite particles into aragonite particles, wherein the aragonite particles are formed on the surface of the vaterite particle; and terminating the transformation of the vaterite particles into the aragonite particles to form a calcium carbonate polymorph composition including vaterite particles and aragonite particles.

Some embodiments relate to a method, wherein the transforming is under one or more transforming conditions including temperature between about 50-400° C., duration between about 10 min-1 hr, and/or relative humidity between about 60%-100%.

Some embodiments relate to a method, wherein the one or more transforming conditions partially transform the vaterite particles to the aragonite particles such that the calcium carbonate polymorph composition includes between about 5-90% by weight of the aragonite particles.

Some embodiments relate to a method, wherein the termination of the transformation includes removing the one or more the transforming conditions.

Some embodiments relate to a method 11-14, further including adding water to the calcium carbonate polymorph composition and transforming the vaterite particles to at least one of the aragonite particles and calcite particles upon dissolution and re-precipitation in water.

Some embodiments relate to a method, further including setting and hardening of at least one of the aragonite particles and calcite particles, and thereby forming a product.

Some embodiments relate to a method 11-16, wherein the aragonite particles accelerate further transformation of the vaterite particles to the aragonite particles when it comes into contact with water thereby accelerates setting and hardening of the calcium carbonate polymorph composition.

Some embodiments relate to a method, wherein the aragonite particles being on the surface of the vaterite particles accelerate transformation of the vaterite particles compared to aragonite particles when physically blended with the vaterite particles.

Some embodiments relate to a method 11-18, further including: calcining limestone to form a mixture including lime and a gaseous stream including carbon dioxide; dissolving the mixture including lime in a device may include a calcium carbonate polymorph composition, including: vaterite particles and aragonite particles, wherein the aragonite particles are formed on the surface of the vaterite particles. N-containing salt solution to produce an aqueous solution including calcium salt; and treating the aqueous solution including calcium salt with the gaseous stream including carbon dioxide to form a wet composition including precipitated calcium carbonate particles.

Some embodiments relate to a method 11-18, further including: dissolving limestone in an N-containing salt solution to produce an aqueous solution including calcium salt, and a gaseous stream including carbon dioxide; and treating the aqueous solution including calcium salt with the gaseous stream including carbon dioxide to form the wet composition including precipitated calcium carbonate particles.

Some embodiments relate to a system to form a calcium carbonate polymorph composition, including: a calcining reactor configured to calcine limestone to form a mixture including lime and a gaseous stream including carbon dioxide; a dissolution reactor operably connected to the calcining reactor configured for dissolving the mixture including lime in an aqueous N-containing salt solution to produce an aqueous solution including calcium salt; a treatment reactor operably connected to the dissolution reactor configured for treating the aqueous solution including calcium salt with the gaseous stream including carbon dioxide to form a wet composition including vaterite particle; and a transforming station, operably connected to the treatment reactor, and configured for transforming the wet composition including vaterite particles under one or more transforming conditions to partially transform the vaterite particles into aragonite particles and forming a calcium carbonate polymorph composition including vaterite particles and aragonite particles, wherein the aragonite particles are formed on surface of the vaterite particles.

Some embodiments relate to a system to form a calcium carbonate polymorph composition, including: a dissolution reactor configured for dissolving limestone with an N-containing salt solution to produce an aqueous solution including calcium salt and a gaseous stream including carbon dioxide; a treatment reactor operably connected to the dissolution reactor configured for treating the aqueous solution including calcium salt with the gaseous stream including carbon dioxide to form a wet composition including vaterite particle; and a transforming station operably connected to the treatment reactor and configured for transforming the wet composition including vaterite particles under one or more transforming conditions to partially transform the vaterite particles into aragonite particles and forming a calcium carbonate polymorph composition including vaterite particles and aragonite particles, wherein the aragonite particles are formed on surface of the vaterite particles.

### DRAWINGS

The features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 illustrates some embodiments of the compositions, methods, and systems provided herein related to the transformation of the vaterite particles to the needle shaped aragonite particles to form the calcium carbonate polymorph composition.

FIG. 2A illustrates some embodiments of the methods and systems provided herein employing calcination of the limestone to form the calcium carbonate polymorph composition.

FIG. 2B illustrates some embodiments of the methods and systems provided herein employing limestone directly to form the calcium carbonate polymorph composition.

FIG. 3A illustrates some embodiments of the methods and systems provided herein employing calcination of the limestone to form the calcium carbonate polymorph composition.

FIG. 3B illustrates some embodiments of the methods and systems provided herein employing limestone directly to form the calcium carbonate polymorph composition.

FIG. 4A illustrates some embodiments of the methods and systems provided herein employing calcination of the limestone to form the calcium carbonate polymorph composition.

FIG. 4B illustrates some embodiments of the methods and systems provided herein employing limestone directly to form the calcium carbonate polymorph composition.

FIG. 5 illustrates SEM images of the calcium carbonate polymorph composition comprising the vaterite particles and the needle shaped aragonite particles grown on the surface of the vaterite particles (2500× magnification on the left and 5000× magnification on the right), as provided in Example 2 herein.

### DESCRIPTION

Disclosed herein are unique compositions, methods, and systems related to the partial transformation of the vaterite particles into the needle shaped aragonite particles grown on the surface of the vaterite particles. The methods and systems provided herein result in a unique calcium carbonate polymorph composition comprising the vaterite particles and the needle shaped aragonite particles grown on the surface of the vaterite particles.

### I. Methods and Systems

### Methods and System to Form the Calcium Carbonate Polymorph Composition

Disclosed herein are methods and systems to form the calcium carbonate polymorph composition described herein. Applicants have devised a unique method to form the calcium carbonate polymorph composition of unique morphology, where the vaterite particles are partially transformed in a controlled manner to obtain needle shaped aragonite particles grown on the surface of the vaterite particles such that no further transformation of the aragonite particles to calcite particles takes place nor are the vaterite particles completely transformed to the aragonite particles. Typically, the vaterite particles tend to be highly unstable polymorph of the calcium carbonate and transform rapidly in contact with water to the aragonite and then to the calcite polymorphic forms. However, the methods and systems provided herein can partially transform the vaterite particles into the aragonite particles with a unique morphology of the needle shaped aragonite grown on the surface of the spherical vaterite, as well as terminate the transformation to form the calcium carbonate polymorph composition which has unique properties.

This unique partial transformation of the vaterite particles to the aragonite particles and the formation of the needle shaped aragonite on the surface of the vaterite particles results in the formation of the calcium carbonate polymorph composition which can be dried and stored for desired period of time. In some embodiments, this calcium carbonate polymorph composition does not transform in the dried form but when comes into contact with water results in the dissolution and re-precipitation of the vaterite particles to transform the vaterite particles into the needle shaped aragonite particles that set and harden into cement and can be used to form various cementitious products.

The calcium carbonate polymorph composition provided herein, due to its morphology results in accelerated transformation of the vaterite particles to the aragonite particles (after coming into the contact with the water) but no further transformation to the calcite particles takes place (or a minor transformation to the calcite particles may take place).

In one aspect, there are provided methods to produce the calcium carbonate polymorph composition, comprising a) forming a wet composition comprising vaterite particles; b) transforming the wet composition comprising vaterite particles under one or more transforming conditions to partially transform the vaterite particles into needle shaped aragonite particles, wherein the needle shaped aragonite particle is formed on surface of the vaterite particle; and c) terminating the transformation of the vaterite particles into the needle shaped aragonite particles to form a calcium carbonate polymorph composition comprising vaterite particles and needle shaped aragonite particles, wherein the needle shaped aragonite particle is formed on the surface of the vaterite particle.

The “wet composition,” the “wet composition comprising vaterite particles,” or the “vaterite cake,” or the “slurry comprising vaterite particles,” are used interchangeably herein and include the composition of the vaterite particles and water in any ratio. The wet composition also includes a dry vaterite composition which when comes into contact with humidity (one of the transforming conditions) forms a wet composition. The “vaterite” or the “vaterite particle” as used herein, includes vaterite material that transforms to the needle shaped aragonite under the one or more transforming conditions described herein, and/or during and/or after dissolution-re-precipitation process in water, sets and hardens into the aragonite.

Some methods and systems to form the wet composition comprising vaterite particles have been described herein. However, any vaterite composition, e.g., a dry vaterite composition can be mixed with the water to form the wet composition comprising the vaterite particles and be subjected to the methods and systems provided herein to form the calcium carbonate polymorph composition. For example, a dry composition may be kept in humidity and other transforming conditions may be applied, as provided herein, to transform the vaterite particles into the needle shaped aragonite particles grown on the surface of the vaterite particles. In some embodiments, the water-to-vaterite particles ratio in the wet composition is between about 0.1:1 to 1.2:1; or between about 0.1:1 to 1:1; or between about 0.1:1-0.5:1; or between about 0.1:1-2:1 by weight.

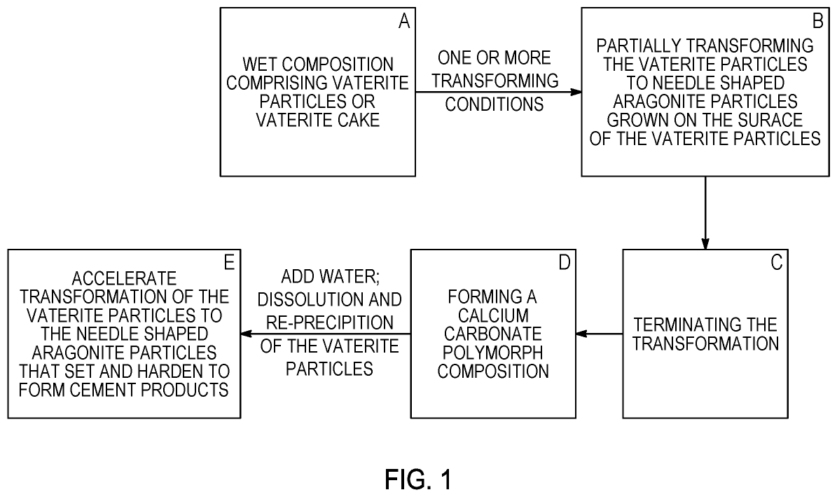

An illustration of the methods and systems aspects is shown in FIG. 1. As illustrated in FIG. 1, the wet composition comprising vaterite particles or the vaterite cake or the slurry comprising vaterite particles A is subjected to one or more transforming conditions to cause partial transformation of the vaterite particles to the aragonite particles where the needle shaped aragonite particles grow on the surface of the vaterite particles B. The vaterite particles can be of any shape and include, without limitation, spherical shape such as, e.g., round shape or rosette shaped vaterite particles.

The one or more transforming conditions include duration of the transforming, temperature of the transforming, and/or humidity during the transforming to partially transform the vaterite particles to the needle shaped aragonite particles on the surface of the vaterite particles. The transforming station in the systems includes, but not limited to, one or more autoclaves, heated conveyer belts, and/or transforming chambers.

In some embodiments, the one or more transforming conditions to partially transform the vaterite particles into the needle shaped aragonite particles comprise temperature between about 50-400° C.; duration between about 10 min-1 hr, or up to 24 hr; and/or relative humidity (RH) between about 60%-100%.

In some embodiments, the one or more transforming conditions to partially transform the vaterite particles into the needle shaped aragonite particles comprise temperature between about 50-400° C.; or between about 50-300° C.; or between about 50-200° C.; or between about 50-100° C.; or between about 50-75° C.; or between about 100-300° C.; or between about 100-200° C.; or between about 200-300° C.; or between about 75-100° C.; duration between about 10 min-1 hr; or between 30 min-1 hr; and/or relative humidity between about 60%-100%; or between about 70%-100%; or between about 80%-100%; or between about 90%-100%; or between about 60%-80%.

In some embodiments, the one or more transforming conditions to partially transform the vaterite particles into the needle shaped aragonite particles comprise temperature of the transforming between about 200-300° C.; duration of the transforming between about 10 min-1 hr; and/or relative humidity during the transforming between about 80%-100%.

These ranges may vary depending on the constitution of the wet composition including its water content or the desired aragonite content.

Applicants unexpectedly found that the transforming conditions described herein can selectively transform the vaterite particles to the needle shaped aragonite particles (without any significant transformation to the calcite particles). The transforming conditions also result in the needle shaped aragonite particles growing on the surface of the vaterite particles to form the calcium carbonate polymorph composition comprising both the vaterite particles and the aragonite particles intertwined in morphology. The unique morphology of the calcium carbonate polymorph composition renders accelerated transformation of the vaterite particles to the aragonite particles during the dissolution re-precipitation process in the water where the aragonite sets and hardens to form cement (step E in FIG. 1). The unique morphology of the calcium carbonate polymorph composition also provides control over the morphology and/or crystal growth of the needle shaped aragonite particles when the calcium carbonate polymorph composition comes into contact with the water (when the vaterite particles undergo dissolution and re-precipitation to form the needle shaped aragonite particles). In some embodiments, the needle shaped aragonite cement thus formed has high tensile strength and fracture tolerance.

In some embodiments, the growth of the aragonite particles on the surface of the vaterite particles is different from the physical mixing of the aragonite particles with the vaterite particles as the physical mixing may not be homogenous and consistent. In some embodiments, the growth of the aragonite particles on the surface of the vaterite particles facilitates the nucleation of the surface of the vaterite particles and enhances growth kinetics when the vaterite undergoes dissolution and re-precipitation to transform to aragonite which sets and hardens into cement.

In some embodiments of the methods provided herein, the one or more transforming conditions comprise:
the duration of the heating between about 10 min-1 hr, or between about 10 min-50 min, or between about 10 min-45 min, or between about 10 min-30 min, or between about 10 min-20 min, or between about 15 min-1 hr, or between about 25 min-1 hr, or between about 30 min-1 hr, or between about 45 min-1 hr;
heat between about 200-300° C., or between about 200-250° C., or between about 225-300° C., or between about 250-300° C., or between about 275-300° C., or between about 225-275° C.;
and/or relative humidity between about 60-100%, or between about 75-100%, or between about 80-100%, or between about 90-100%, or between about 80-90%, or 70%, or 80%, or 90%, or 98%, or 99.9%, or 100%.

In some embodiments, the transforming conditions provide heat and humidity in the form of steam to the wet composition comprising vaterite particles. The combination of the one or more transforming conditions, such as the temperature, the relative humidity, and the time of exposure or the duration, etc., are varied to obtain the required percentage of the aragonite in the calcium carbonate polymorph composition.

Applicants also surprisingly and unexpectedly found that the transforming conditions can also affect the average particle size of the needle shaped aragonite growing on the surface of the vaterite particles. For example, in some embodiments, prolonging the duration of the heating, increasing the temperature, and/or increasing the relative humidity can increase the average particle size of the aragonite particle. In some embodiments, the average particle size of the needle shaped aragonite on the surface of the vaterite particles can affect the nucleation and the growth kinetics during the transformation of the vaterite to the aragonite during and/or after the dissolution and re-precipitation process. Accordingly in some embodiments, there are provided methods and systems to vary the one or more transforming conditions to increase or decrease the average particle size of the needle shaped aragonite.

In some embodiments, the one or more transforming conditions partially transform the vaterite particles to the needle shaped aragonite particles, wherein the calcium carbonate polymorph composition comprises between about 5-90% by weight of the needle shaped aragonite particles. In some embodiments, the calcium carbonate polymorph composition comprises between about 5-90% by weight aragonite; or between about 10-90% by weight aragonite; or between about 10-80% by weight aragonite; or between about 10-70% by weight aragonite; or between about 10-60% by weight aragonite; or between about 10-50% by weight aragonite; or between about 10-40% by weight aragonite; or between about 10-30% by weight aragonite; or between about 10-20% by weight aragonite; or between about 20-90% by weight aragonite; or between about 30-90% by weight aragonite; or between about 40-90% by weight aragonite; or between about 50-90% by weight aragonite; or between about 60-90% by weight aragonite; or between about 70-90% by weight aragonite; or between about 20-50% by weight aragonite; or between about 30-50% by weight aragonite; or between about 70-90% by weight aragonite, with the remaining being vaterite particles by weight.

In some embodiments, the partial transformation of the vaterite particles into the needle shaped aragonite particles grown on the surface of the vaterite particles is terminated (step C in FIG. 1) when the calcium carbonate polymorph composition comprises between about 5-90% by weight of the needle shaped aragonite particles.

In some embodiments of the methods described herein, the methods further comprise terminating the transformation of the vaterite particles into the needle shaped aragonite particles by removing the one or more of the transforming conditions of temperature and/or humidity. For example, in some embodiments, the transformation can be terminated by reducing the temperature of the transforming conditions to below 400° C. or below 200° C. or below 100° C. or below 50° C. and/or reducing the RH to below 70% or below 60% or below 50% or below 40%.

In some embodiments of the methods described herein, after the termination of the transformation, the methods further comprise fully drying the calcium carbonate polymorph composition (step D in FIG. 1) at below 200° C. or below 150° C. or below 100° C. or at room temperature and low or no humidity or RH below 60% so no further transformation of the vaterite particles to the aragonite particles takes place. The dried calcium carbonate polymorph composition can be stored for a long period of time such as e.g., for hours, days, months or years where the co-existent vaterite and the aragonite stay stable.

In some embodiments, the calcium carbonate polymorph composition can be used anytime as a cement to form cementitious products or concrete or mortar. In some embodiments, the methods further comprise adding water to the calcium carbonate polymorph composition and transforming the remaining vaterite particles to the needle shaped aragonite particles and/or optionally to some calcite particles upon dissolution and re-precipitation in water (step E in FIG. 1). The needle shaped aragonite particles (optionally further comprising minor amount of the calcite particles) set and harden to form the cement or the cementitious products.

In some embodiments, the methods and systems described herein further comprise producing the wet composition comprising the vaterite particles. The methods and systems to produce the wet composition have been described herein.

### Methods and Systems to Produce the Wet Composition Comprising Vaterite Particle

The wet composition comprising vaterite particles that is used to produce the calcium carbonate polymorph composition can be prepared using methods and systems provided herein.

In one aspect there are provided methods for forming the wet composition, comprising: (a) calcining limestone to form a mixture comprising lime and a gaseous stream comprising carbon dioxide; (b) dissolving the mixture comprising lime in a N-containing salt solution to produce an aqueous solution comprising calcium salt; and (c) treating the aqueous solution comprising calcium salt with the gaseous stream comprising carbon dioxide to form the wet composition comprising vaterite particles.

In one aspect there are provided methods for forming the wet composition, comprising: (a) dissolving limestone in a N-containing salt solution to produce an aqueous solution comprising calcium salt, and a gaseous stream comprising carbon dioxide; and (b) treating the aqueous solution comprising calcium salt with the gaseous stream comprising carbon dioxide to form the wet composition comprising vaterite particles.

In one aspect there are provided systems, comprising:
(i) a calcining reactor configured to calcine limestone to form a mixture comprising lime and a gaseous stream comprising carbon dioxide;
(ii) a dissolution reactor operably connected to the calcination reactor configured for dissolving the mixture comprising lime in an aqueous N-containing salt solution to produce an aqueous solution comprising calcium salt;
(iii) a treatment reactor operably connected to the dissolution reactor configured for treating the aqueous solution comprising calcium salt with the gaseous stream comprising carbon dioxide to form the wet composition comprising vaterite particle; and
(iv) the transforming station operably connected to the treatment reactor and configured for transforming the wet composition comprising vaterite particles under the one or more transforming conditions to partially transform the vaterite particles into the needle shaped aragonite particles and forming the calcium carbonate polymorph composition comprising vaterite particles and needle shaped aragonite particles, wherein the needle shaped aragonite particle is formed on the surface of the vaterite particle.

In one aspect there are provided systems, comprising:
(i) a dissolution reactor configured for dissolving limestone with N-containing salt solution to produce an aqueous solution comprising calcium salt and a gaseous stream comprising carbon dioxide;
(ii) a treatment reactor operably connected to the dissolution reactor configured for treating the aqueous solution comprising calcium salt with the gaseous stream comprising carbon dioxide to form the wet composition comprising vaterite particle; and
(iii) a transforming station operably connected to the treatment reactor and configured for transforming the wet composition comprising vaterite particles under one or more transforming conditions to partially transform the vaterite particles into the needle shaped aragonite particles and forming the calcium carbonate polymorph composition comprising vaterite particles and needle shaped aragonite particles wherein the needle shaped aragonite particle is formed on surface of the vaterite particle.

The transforming station and the one or more transforming conditions have been described herein.

In some embodiments of the foregoing aspects and embodiments, the transforming station is one or more autoclaves. In some embodiments of the foregoing aspects and embodiments, the system further comprises a control system configured to remotely and/or automatedly control the system.

In some embodiments of the foregoing aspects and embodiments, the system further comprises a blending reactor operably connected to the treatment reactor configured for blending one or more other components selected from the group consisting of limestone, aluminosilicate material, aggregate, slag from metal production, Portland cement clinker, calcium aluminate cement clinker, calcium sulfoaluminate cement clinker, carbonate material, alkali metal accelerator, an alkaline earth metal accelerator, admixture, additive, SCM, and combination thereof, with the wet composition.

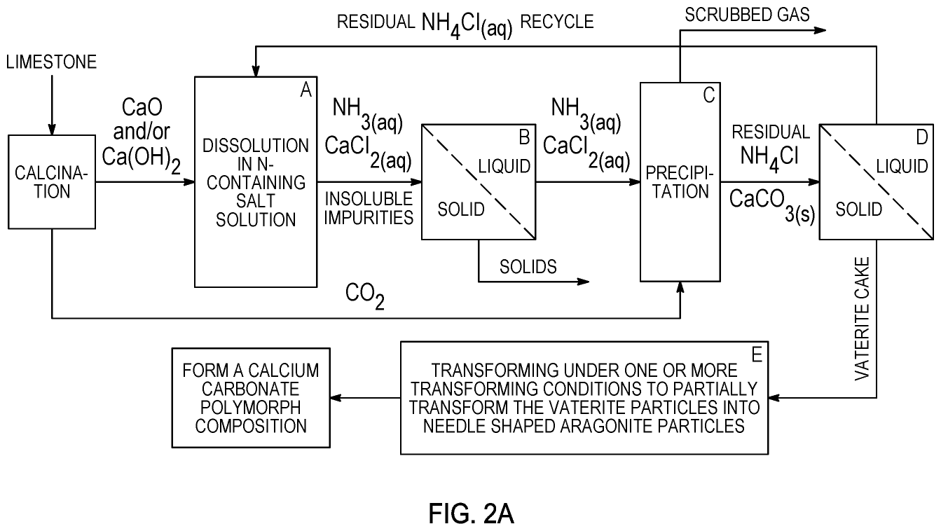

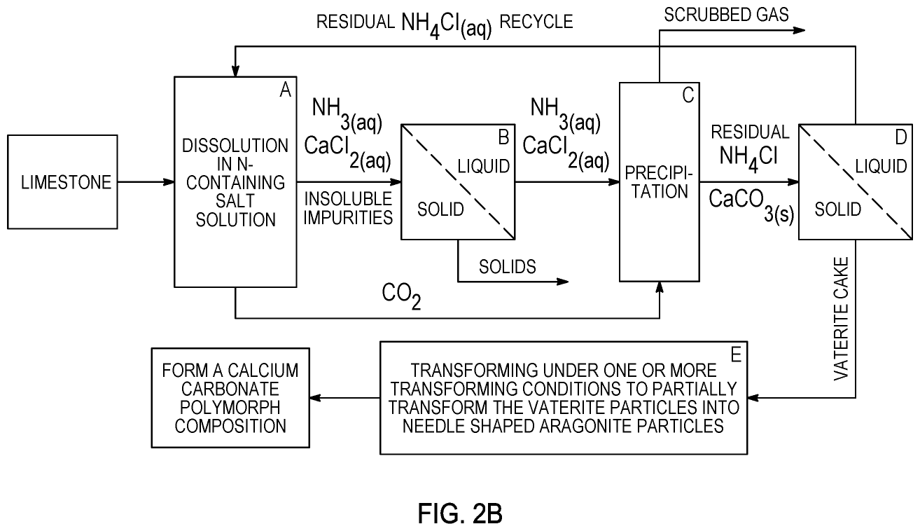

The wet composition comprising vaterite particles can be prepared using various methods and systems, as described further herein and illustrated in FIGS. 2A, 2B, 3A, 3B, 4A, and 4B. The wet composition comprising vaterite particles can be produced using the limestone as a feedstock where the limestone is used as is in the process or is calcined to form the lime. The methods and systems provided herein to produce the wet composition comprising vaterite particles have several advantages, such as but not limited to, reduction of carbon dioxide emissions through the incorporation of the carbon dioxide back into the process to form the wet composition. Production of the wet composition, in the methods and systems provided herein, offers advantages including operating expense savings through the reduction in fuel consumption, and reductions in carbon footprint. In the methods and systems provided herein, the emissions of the CO₂ from the calcination of the limestone to the lime may be avoided by recapturing it back in the composition. By recapturing the carbon dioxide, the composition has the potential to eliminate significant amount of the cement carbon dioxide emissions and total global emissions from all sources. The compositions provided herein can be used as a self-cement and/or to replace Ordinary Portland Cement (OPC) or Portland cement clinker either entirely or partially as SCM.

In some embodiments, the limestone can be used directly to form the wet composition (as illustrated in FIGS. 2B, 3B, and 4B) or the limestone may be calcined to form the lime which may be used to form the wet composition comprising vaterite particles (as illustrated in FIGS. 2A, 3A, and 4A). The aforementioned aspects and embodiments of the methods and systems provided herein are as illustrated in FIGS. 2A, 2B, 3A, 3B, 4A, and 4B. It is to be understood that the steps illustrated in the figures may be modified or the order of the steps may be changed or more steps may be added or deleted depending on the desired outcome.

Calcination or calcining is a thermal treatment process to bring about a thermal decomposition of the limestone. The “limestone” as used herein, means CaCO₃ and may further include other impurities typically present in the limestone. Limestone is a naturally occurring mineral. The chemical composition of this mineral may vary from region to region as well as between different deposits in the same region. Therefore, the lime containing the calcium oxide and/or the calcium hydroxide obtained from calcining limestone from each natural deposit may be different. Typically, limestone may be composed of calcium carbonate (CaCO₃), magnesium carbonate (MgCO₃), silica (SiO₂), alumina (Al₂O₃), iron (Fe), sulphur(S) or other trace elements.

Limestone deposits are widely distributed. The limestone from the various deposits may differ in physical chemical properties and can be classified according to their chemical composition, texture, and geological formation. Limestone may be classified into the following types: high calcium limestone where the carbonate content may be composed mainly of calcium carbonate with a magnesium carbonate content not more than 5%; magnesium limestone containing magnesium carbonate to about 5-35%; or dolomitic limestone which may contain between 35-46% of MgCO₃, the balance amount is calcium carbonate. Limestones from different sources may differ considerably in chemical compositions and physical structures. It is to be understood that the methods and systems provided herein apply to all the cement plants calcining the limestone from any of the sources listed above or commercially available. The quarries include, but are not limited to, quarries associated with cement kiln, quarries for lime rock for aggregate for use in concrete, quarries for lime rock for other purposes (road base), and/or quarries associated with lime kiln.

The limestone calcination is a decomposition process where the chemical reaction for the decomposition of the limestone is:

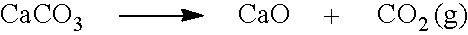

This step is illustrated in FIGS. 2A, 3A, and 4A as a first step of the calcination of the limestone to form the lime. However, in some embodiments, the calcination step can be obviated, and the limestone is used directly as a feed stock (FIGS. 2B, 3B, and 4B).

In some embodiments, the limestone comprises between about 1-70% magnesium and/or a magnesium bearing mineral is mixed with the limestone before the calcination wherein the magnesium bearing mineral comprises between about 1-70% magnesium. In some embodiments, the magnesium upon the calcination forms the magnesium oxide which may be precipitated and/or incorporated in the wet composition comprising the vaterite particle and/or the calcium carbonate polymorph composition, once formed. In some embodiments, the magnesium bearing mineral comprises magnesium carbonate, magnesium salt, magnesium hydroxide, magnesium silicate, magnesium sulfate, or combinations thereof. In some embodiments, the magnesium bearing mineral includes, but not limited to, dolomite, magnesite, brucite, carnallite, talc, olivine, artinite, hydromagnesite, dypingite, barringonite, nesquehonite, lansfordite, kieserite, and combinations thereof. In some embodiments, the magnesium oxide in the wet composition comprising the vaterite particle and/or the calcium carbonate polymorph composition when comes into contact with water, transforms to magnesium hydroxide which may bind with the transformed aragonite and/or calcite.

The “lime” as used herein relates to calcium oxide and/or calcium hydroxide. The presence and amount of the calcium oxide and/or the calcium hydroxide in the lime would vary depending on the conditions for the lime formation. The lime may be in dry form i.e., calcium oxide, and/or in wet form e.g., calcium hydroxide, depending on the conditions. The production of the lime may depend upon the type of kiln, conditions of the calcination, and the nature of the raw material i.e., limestone. In some embodiments, at relatively low calcination temperatures, products formed in the kiln may contain both un-burnt carbonate and lime and may be called underburnt lime. In some embodiments, as the temperature increases, soft burnt or high reactive lime may be produced. In some embodiments, at still higher temperatures, dead burnt or low reactive lime may be produced. The soft burnt lime may be produced when the reaction front reaches the core of the charged limestone and converts all carbonate present to lime. A high productive product may be relatively soft, contains small lime crystallites and has open porous structure with an easily assessable interior. Such lime may have the optimum properties of high reactivity, high surface area and low bulk density. Increasing the degree of calcination beyond this stage may make lime crystallites grow larger, agglomerate and sinter. This may result in a decrease in surface area, porosity and reactivity and an increase in bulk density. This product may be known as dead burnt or low reactive lime. Without being limited by any theory, the methods and systems provided herein form and utilize any one or the combination of the aforementioned lime. Therefore, in some embodiments, the lime is dead burnt, soft burnt, underburnt, or combinations thereof. In some embodiments, the lime is dead burnt lime. In some embodiments, the lime is under burnt lime. In some embodiments, the lime is soft burnt lime. In some embodiments, the lime is dead burnt lime, soft burnt lime, or combination thereof.

Production of the lime by calcining the limestone may be carried out using various types of kilns, such as, but not limited to, a shaft kiln or a rotary kiln or an electric kiln. The use of the electric kiln in the calcination and the advantages associated with it, have been described in U.S. application Ser. No. 17/363,537, filed Jun. 30, 2021, which is fully incorporated herein by reference in its entirety.

These apparatuses for calcining are suitable for calcining the limestone in the form of lumps having diameters of several to tens millimeters. Cement plant waste streams include waste streams from both wet process and dry process plants, which plants may employ shaft kilns, rotary kilns, electric kilns, or combinations thereof and may include pre-calciners. These industrial plants may each burn a single fuel or may burn two or more fuels sequentially or simultaneously.

As illustrated in FIGS. 2A, 2B, 3A, 3B, 4A, and 4B, the limestone obtained from the limestone quarry is subjected to the calcination in a cement plant resulting in the formation of the lime and CO₂ gas or is used directly. The lime may be calcium oxide in the form of a solid from dry kilns/cement processes and/or may be a combination of calcium oxide and calcium hydroxide in the form of slurry in wet kilns/cement processes. When wet the calcium oxide (also known as a base anhydride that converts to its hydroxide form in water) may be present in its hydrated form such as but not limited to, calcium hydroxide. While calcium hydroxide (also called slaked lime) is a common hydrated form of calcium oxide, other intermediate hydrated and/or water complexes may also be present in the slurry and are all included within the scope of the methods and systems provided herein. It is to be understood that while the lime is illustrated as CaO in some of the figures herein, it may be present as Ca(OH)₂ or combination of CaO and Ca(OH)₂.

The lime or the limestone may be sparingly soluble in water. In the methods and systems provided herein, the lime or the limestone solubility is increased by its treatment with solubilizers.

In the methods and systems provided herein, the lime or the limestone is solvated or dissolved or solubilized with a solubilizer (step A in FIGS. 2A, 2B, 3A, 3B, 4A, and 4B) to produce an aqueous solution comprising calcium salt. For illustration purposes only, the solubilizer, e.g., N-containing salt solution is being illustrated in the figures as ammonium chloride (NH₄Cl) solution and the subsequent calcium salt is being illustrated as calcium chloride (CaCl₂)). Various examples of the N-containing salt have been provided herein and are all within the scope of the invention.

In some embodiments, the N-containing salt solution solubilizes or dissolves the calcium from the lime or the limestone and leaves the solid impurities. The N-containing salt include without limitation, N-containing inorganic salt, N-containing organic salt, or combination thereof.

The “N-containing inorganic salt” as used herein includes any inorganic salt with nitrogen in it. Examples of N-containing inorganic salt include, but not limited to, ammonium acetate, ammonium halide (halide is any halogen), ammonium sulfate, ammonium sulfite, ammonium nitrate, ammonium nitrite, and the like. In some embodiments, the ammonium halide is ammonium chloride or ammonium bromide. In some embodiments, the ammonium halide is ammonium chloride.

The “N-containing organic salt” as used herein includes any salt of an organic compound with nitrogen in it. Examples of N-containing organic compounds include, but not limited to, aliphatic amine, alicyclic amine, heterocyclic amine, and combinations thereof.

The “aliphatic amine” as used herein includes any alkyl amine of formula (R)ₙ—NH₃₋ₙ where n is an integer from 1-3, wherein R is independently between C1-C8 linear or branched and substituted or unsubstituted alkyl. An example of the corresponding halide salt (chloride salt, bromide salt, fluoride salt, or iodide salt) of the alkyl amine of formula (R)ₙ—NH₃₋ₙ is (R)ₙ—NH₄₋ₙ⁺Cl⁻. In some embodiments, when R is substituted alkyl, the substituted alkyl is independently substituted with halogen, hydroxyl, acid and/or ester.

For example, when R is alkyl in (R)ₙ—NH₃₋ₙ, the alkyl amine can be a primary alkyl amine, such as for example only, methylamine, ethylamine, butylamine, pentylamine, etc.; the alkyl amine can be a secondary amine, such as for example only, dimethylamine, diethylamine, methylethylamine, etc.; and/or the alkyl amine can be a tertiary amine, such as for example only, trimethylamine, triethylamine, etc.

For example, when R is substituted alkyl substituted with hydroxyl in (R)ₙ—NH₃₋ₙ, the substituted alkyl amine is an alkanolamine including, but not limited to, monoalkanolamine, dialkanolamine, or trialkanolamine, such as e.g., monoethanolamine, diethanolamine, or triethanolamine, etc.

For example, when R is substituted alkyl substituted with halogen in (R)ₙ—NH₃₋ₙ, the substituted alkyl amine is, for example, chloromethylamine, bromomethylamine, chloroethylamine, bromoethylamine, etc.

For example, when R is substituted alkyl substituted with acid in (R)ₙ—NH₃₋ₙ, the substituted alkyl amine is, for example, amino acids. In some embodiments, the aforementioned amino acid has a polar uncharged alkyl chain, examples include without limitation, serine, threonine, asparagine, glutamine, or combinations thereof. In some embodiments, the aforementioned amino acid has a charged alkyl chain, examples include without limitation, arginine, histidine, lysine, aspartic acid, glutamic acid, or combinations thereof. In some embodiments, the aforementioned amino acid is glycine, proline, or combination thereof.

The “alicyclic amine” as used herein includes any alicyclic amine of formula (R)ₙ—NH₃₋ₙ where n is an integer from 1-3, wherein R is independently one or more all-carbon rings which may be either saturated or unsaturated, but do not have aromatic character. Alicyclic compounds may have one or more aliphatic side chains attached. An example of the corresponding salt of the alicyclic amine of formula (R)ₙ—NH₃₋ₙ is (R)ₙ—NH₄₋ₙ⁺Cl⁻. Examples of alicyclic amine include, without limitation, cycloalkylamine: cyclopropylamine, cyclobutylamine, cyclopentylamine, cyclohexylamine, cycloheptylamine, cyclooctylamine, and so on.

The “heterocyclic amine” as used herein includes at least one heterocyclic aromatic ring attached to at least one amine. Examples of heterocyclic rings include, without limitation, pyrrole, pyrrolidine, pyridine, pyrimidine, etc. Such chemicals are well known in the art and are commercially available.

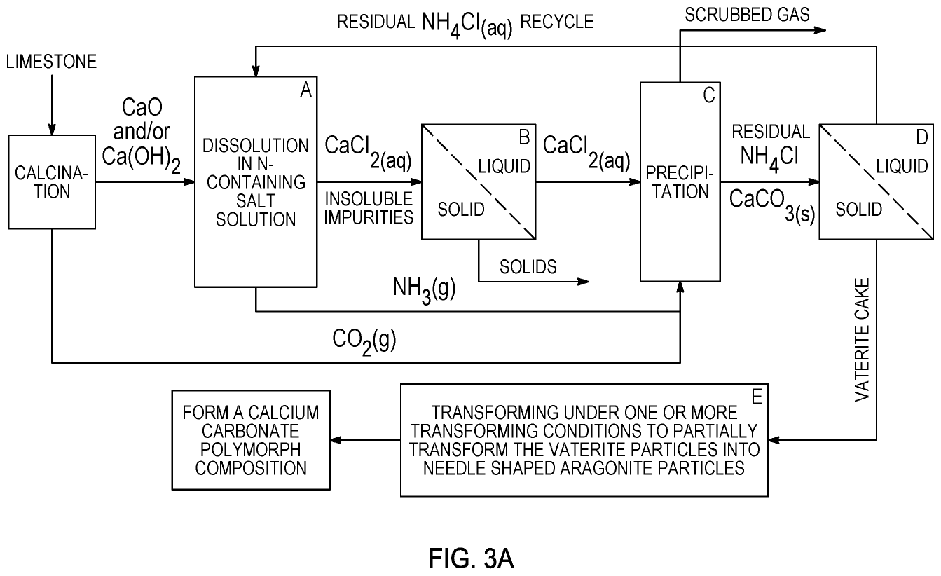

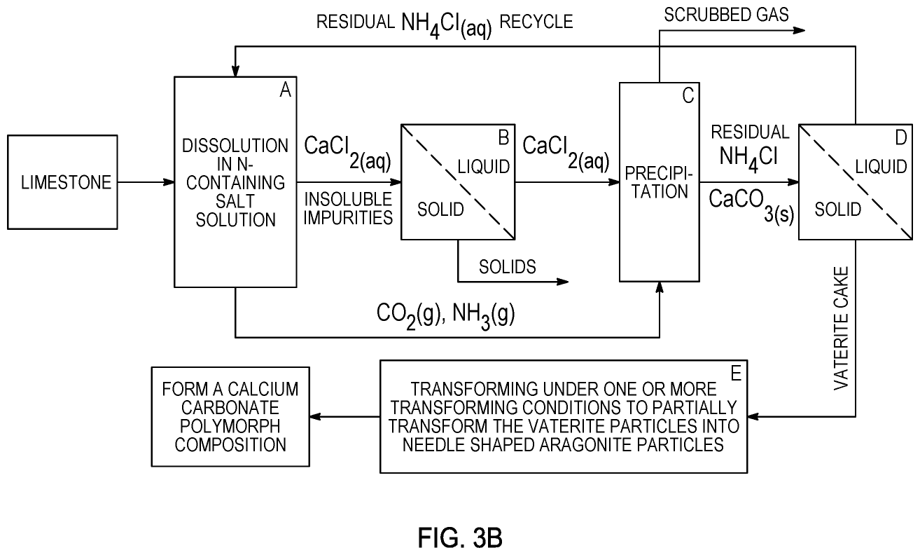

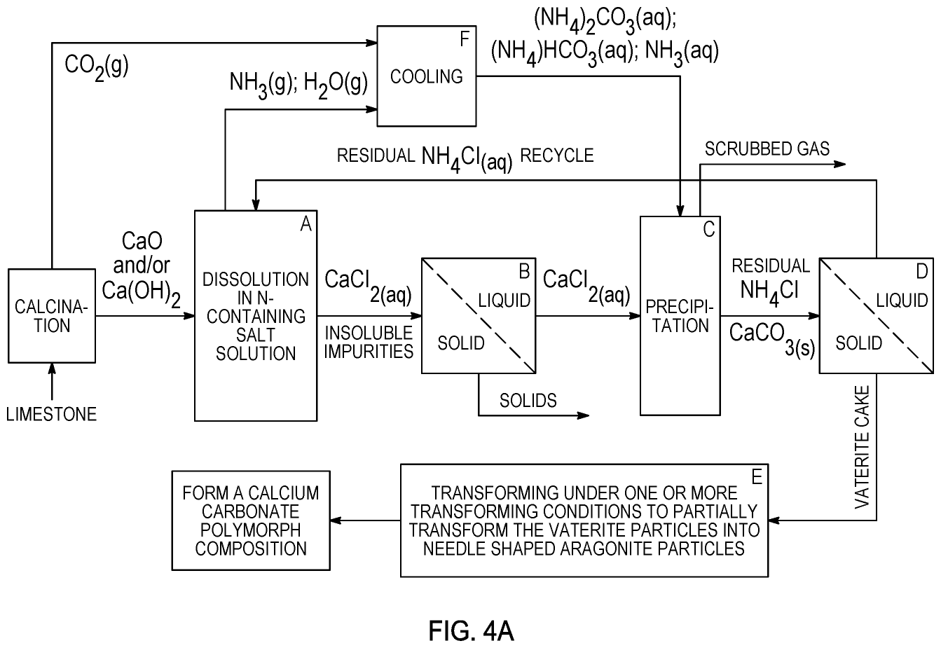

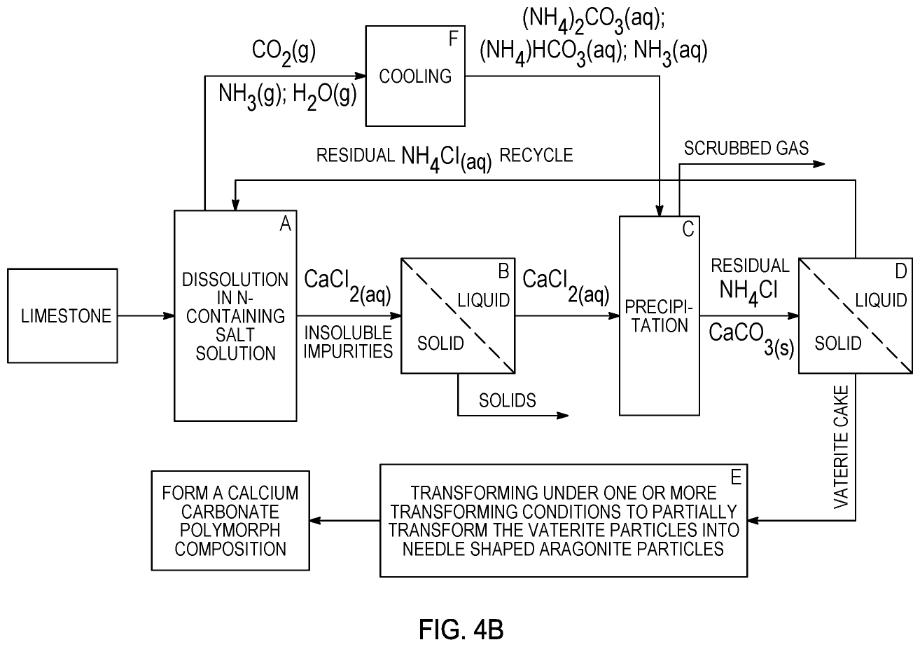

In the methods and systems provided herein, the limestone or the lime is dissolved or solubilized with the N-containing salt solution (step A) to produce the aqueous solution comprising calcium salt. The dissolution step may form ammonia in the aqueous solution (illustrated in FIGS. 2A and 2B) and/or form a gaseous stream comprising ammonia gas (illustrated in FIGS. 3A, 3B, 4A, and 4B).

As illustrated in step A of FIGS. 2A, 3A, and 4A, the N-containing salt is exemplified as ammonium chloride (NH₄Cl). The lime is solubilized by treatment with NH₄Cl (new and recycled as further explained below) when the reaction that may occur is:

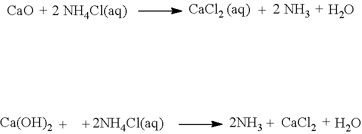 [SMILES: O ; "CaO" ; "Ca(OH)2" ; "CaCl2" ; O]

Similarly, when the N-containing salt is N-containing organic salt, the reaction may be shown as below:

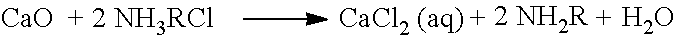

Similarly, illustrated in step A of FIGS. 2B, 3B, and 4B, the N-containing salt is exemplified as ammonium chloride (NH₄Cl). The limestone is solubilized by treatment with NH₄Cl (new and recycled as further explained below) when the reaction that may occur is:

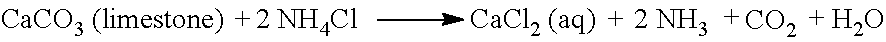

Similarly, when the base is N-containing organic salt, the reaction may be shown as below:

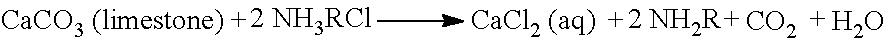

In some embodiments, the base or the N-containing inorganic salt such as, but not limited to, an ammonium salt, e.g., ammonium chloride solution may be supplemented with anhydrous ammonia or an aqueous solution of ammonia to maintain an optimum level of ammonium chloride in the solution.

In some embodiments, the aqueous solution comprising calcium salt obtained after dissolution of the lime or the limestone may contain sulfur depending on the source of the limestone. The sulfur may get introduced into the aqueous solution after the solubilization of the lime or the limestone with any of the N-containing salt described herein. In an alkaline solution, various sulfur compounds containing various sulfur ionic species may be present in the solution including, but not limited to, sulfite (SO₃²⁻), sulfate (SO₄²⁻), hydrosulfide (HS⁻), thiosulfate (S₂O₃²⁻), polysulfides (Sₙ²⁻), thiol (RSH), and the like. The “sulfur compound” as used herein, includes any sulfur ion containing compound.

In some embodiments, the aqueous solution further comprises the N-containing salt, such as, ammonia and/or N-containing inorganic or N-containing organic salt.

In some embodiments, the amount of the N-containing inorganic salt, the N-containing organic salt, or combinations thereof, is in more than 20% excess or more than 30% excess to the lime or the limestone. In some embodiments, the molar ratio of the N-containing salt:lime (or N-containing inorganic salt:lime or N-containing organic salt:lime or ammonium chloride:lime) or the molar ratio of the N-containing salt:limestone (or N-containing inorganic salt:limestone or N-containing organic salt:limestone or ammonium chloride:limestone) is between 0.5:1-2:1; or 0.5:1-1.5:1; or 1:1-1.5:1; or 1.5:1; or 2:1; or 2.5:1; or 1:1.

In some embodiments of the methods and systems described herein, the dissolution step takes place under one or more dissolution conditions selected from the group consisting of temperature between about 30-200° C., or between about 30-150° C., or between about 30-100° C., or between about 30-75° C., or between about 30-50° C., or between about 40-200° C., or between about 40-150° C., or between about 40-100° C., or between about 40-75° C., or between about 40-50° C., or between about 50-200° C., or between about 50-150° C., or between about 50-100° C.; pressure between about 0.1-50 atm, or between about 0.1-40 atm, or between about 0.1-30 atm, or between about 0.1-20 atm, or between about 0.1-10 atm, or between about 0.5-20 atm; N-containing inorganic or organic salt wt % in water between about 0.5-50%, or between about 0.5-25%, or between about 0.5-10%, or between about 3-30%, or between about 5-20%; or combination thereof.

Agitation may be used to affect dissolution of the lime or the limestone with the N-containing salt solution in the dissolution reactor, for example, by eliminating hot and cold spots to optimize the dissolution/solvation of the lime or the limestone, high shear mixing, wet milling, and/or sonication may be used to break open the lime or the limestone. During or after high shear mixing and/or wet milling, the lime or the limestone suspension may be treated with the N-containing salt solution.

In some embodiments, the dissolution of the lime or the limestone with the N-containing salt solution (illustrated as e.g., ammonium chloride) results in the formation of the aqueous solution comprising calcium salt and solid. In some embodiments, the solid insoluble impurities may be removed from the aqueous solution of the calcium salt (step B in FIGS. 2A, 2B, 3A, 3B, 4A, and 4B) before the aqueous solution is treated with the carbon dioxide in the process. The solid may optionally be removed from the aqueous solution by filtration and/or centrifugation techniques. In some embodiments, the separated solid may be mixed back in the calcium carbonate polymorph composition as a filler.

It is to be understood that the step B in FIGS. 2A, 2B, 3A, 3B, 4A, and 4B is optional and in some embodiments, the solid may not be removed from the aqueous solution (not shown in the figures) and the aqueous solution containing calcium salt as well as the solid is contacted with the carbon dioxide (in step C in FIGS. 2A, 2B, 3A, 3B, 4A, and 4B) to form the precipitate. In such embodiments, the precipitation material or the wet composition comprising vaterite particle further comprises solid.

In some embodiments, the solid obtained from the dissolution of the lime or the limestone (shown as insoluble impurities in FIGS. 2A, 2B, 3A, 3B, 4A, and 4B) is calcium depleted solid and may be used as a cement substitute (such as a substitute for Portland cement). In some embodiments, the solid comprises silicate, iron oxide, alumina, or combination thereof. The silicate includes, without limitation, clay (phyllosilicate), alumino-silicate, etc.

In some embodiments, the solid is between about 1-85 wt %; or between about 1-80 wt %; or between about 1-75 wt %; or between about 1-70 wt %; or between about 1-60 wt %; or between about 1-50 wt %; or between about 1-40 wt %; or between about 1-30 wt %; or between about 1-20 wt %; or between about 1-10 wt % or between about 1-5 wt %; or between about 1-2 wt %, in the aqueous solution, in the precipitation material, in the wet composition, in the calcium carbonate polymorph composition, or combination thereof.

As illustrated in step C in FIGS. 2A, 2B, 3A, 3B, 4A, and 4B, the aqueous solution comprising calcium salt (and optionally solid) and dissolved ammonia and/or ammonium salt is contacted with the gaseous stream comprising carbon dioxide recycled from the calcination step of the limestone calcination process or the dissolution step of the direct limestone process, to form the precipitation material comprising calcium carbonate, wherein the calcium carbonate comprises vaterite particles, shown in the reaction below:

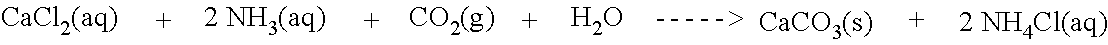

The absorption of the CO₂ into the aqueous solution produces CO₂-charged water containing carbonic acid, a species in equilibrium with both bicarbonate and carbonate. The precipitation material is prepared under one or more precipitation conditions (as described herein) suitable to form the vaterite particles.

In one aspect, the ammonia formed in the dissolution step A may be partially or fully present in a gaseous form. This aspect is illustrated in FIGS. 3A and 3B.

In one aspect, there are provided methods to form the wet composition comprising (a) calcining the limestone to form the mixture comprising lime and the gaseous stream comprising carbon dioxide; (b) dissolving the mixture comprising lime in the N-containing salt solution to produce the aqueous solution comprising calcium salt, and the gaseous stream comprising ammonia; and (c) treating the aqueous solution comprising calcium salt with the gaseous stream comprising carbon dioxide and the gaseous stream comprising ammonia to form the wet composition comprising vaterite particles. This aspect is illustrated in FIG. 3A, wherein the gaseous stream comprising CO₂ from the calcination step and the gaseous stream comprising NH₃ from step A of the process is recirculated to the precipitation reactor (step C) for the formation of the vaterite precipitate. The remaining steps of FIG. 3A are identical to the steps of FIG. 2A. It is to be understood that the processes of both FIG. 2A and FIG. 3A can also take place simultaneously such that the N-containing salt, such as the N-containing inorganic salt or the N-containing organic salt and optionally ammonia may be partially present in the aqueous solution and partially present in the gaseous stream.

The reaction taking place in the aforementioned aspect may be shown as below:

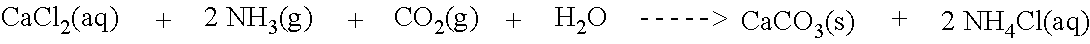

In one aspect, there are provided methods to form the wet composition comprising (a) dissolving the limestone in the N-containing salt solution to produce the aqueous solution comprising calcium salt, and the gaseous stream comprising ammonia and the gaseous stream comprising carbon dioxide; and (c) treating the aqueous solution comprising calcium salt with the gaseous stream comprising carbon dioxide and the gaseous stream comprising ammonia to form the wet composition comprising vaterite particles. This aspect is illustrated in FIG. 3B, wherein the gaseous stream comprising CO₂ and the gaseous stream comprising NH₃ from step A of the process is recirculated to the precipitation reactor (step C) for the formation of the vaterite precipitate. The remaining steps of FIG. 3B are identical to the steps of FIG. 2B. It is to be understood that the processes of both FIG. 2B and FIG. 3B can also take place simultaneously such that the N-containing salt, such as the N-containing inorganic salt or the N-containing organic salt and optionally ammonia may be partially present in the aqueous solution and partially present in the gaseous stream.

In some embodiments of the aspects and embodiments provided herein, the gaseous stream comprising ammonia may have ammonia from an external source and/or is recovered and re-circulated from step A of the process.

In some embodiments of the aspects and embodiments provided herein, wherein the gaseous stream comprises ammonia and/or the gaseous stream comprises carbon dioxide, no external source of carbon dioxide and/or ammonia is used, and the process is a closed loop process. Such a closed loop process is being illustrated in the figures described herein.

In some embodiments, the dissolution of the lime or the limestone with some of the N-containing organic salt may not result in the formation of ammonia gas or the amount of ammonia gas formed may not be substantial. In embodiments where the ammonia gas is not formed or is not formed in substantial amounts, the methods and systems illustrated in FIGS. 2A and 2B where the aqueous solution comprising calcium salt is treated with the carbon dioxide gas, are applicable. In some embodiments, the organic amine salt may remain in the aqueous solution in fully or partially dissolved state or may separate as an organic amine layer, as shown in the reaction below:

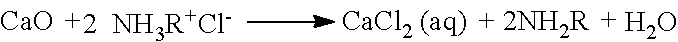

The N-containing organic salt or the N-containing organic compound remaining in the supernatant solution after the precipitation may be called residual N-containing organic salt or residual N-containing organic compound. Methods and systems have been described herein to recover the residual compounds from the precipitate as well as the supernatant solution.

In one aspect, the ammonia gas and the CO₂ gas may be recovered and cooled down in a cooling reactor before mixing the cooled solution with the aqueous solution comprising calcium salt. This aspect is illustrated in FIGS. 4A and 4B.

In one aspect, there are provided methods to form the wet composition comprising (i) calcining the limestone to form the lime and the gaseous stream comprising carbon dioxide; (ii) dissolving the lime in the aqueous N-containing inorganic salt solution or N-containing organic salt solution to produce the first aqueous solution comprising calcium salt, and the gaseous stream comprising ammonia; (iii) recovering the gaseous stream comprising carbon dioxide and the gaseous stream comprising ammonia and subjecting the gaseous streams to a cooling process to condense a second aqueous solution comprising ammonium bicarbonate, ammonium carbonate, ammonia, ammonium carbamate, or combination thereof; and (iv) treating the first aqueous solution comprising calcium salt with the second aqueous solution comprising ammonium bicarbonate, ammonium carbonate, ammonia, ammonium carbamate, or combination thereof to form the wet composition comprising vaterite particles. This aspect is illustrated in FIG. 4A, wherein the gaseous stream comprising CO₂ from the calcination step and the gaseous stream comprising NH₃ from step A of the process is recirculated to the cooling reactor/reaction (step F) for the formation of the carbonate and bicarbonate solutions as shown in the reactions further herein below. Remaining steps of FIG. 4A are identical to the steps of FIGS. 2A and 3A.

It is to be understood that the aforementioned aspect illustrated in FIG. 4A may be combined with the aspects illustrated in FIG. 2A and/or FIG. 3A such that the precipitation step C comprises treating the first aqueous solution comprising calcium salt with the second aqueous solution comprising ammonium bicarbonate, ammonium carbonate, ammonia, ammonium carbamate, or combination thereof (illustrated in FIG. 4A), as well as comprises treating the aqueous solution comprising calcium salt with the gaseous stream comprising carbon dioxide (illustrated in FIG. 2A) and/or comprises treating the aqueous solution comprising calcium salt with the gaseous stream comprising carbon dioxide and the gaseous stream comprising ammonia (illustrated in FIG. 3A). In such embodiments, the gaseous stream comprising carbon dioxide is split between the stream going to the cooling process and the stream going to the precipitation process. Similarly, in such embodiments, the gaseous stream comprising ammonia is split between the stream going to the cooling process and the stream going to the precipitation process. Any combination of the processes depicted in FIGS. 2A, 3A, and 4A is possible and all are within the scope of this disclosure.

In one aspect, there are provided methods to form the wet composition comprising (i) dissolving the limestone in the aqueous N-containing inorganic salt solution or N-containing organic salt solution to produce the first aqueous solution comprising calcium salt, the gaseous stream comprising carbon dioxide and the gaseous stream comprising ammonia; (ii) recovering the gaseous stream comprising carbon dioxide and the gaseous stream comprising ammonia and subjecting the gaseous streams to a cooling process to condense a second aqueous solution comprising ammonium bicarbonate, ammonium carbonate, ammonia, ammonium carbamate, or combination thereof; and (iii) treating the first aqueous solution comprising calcium salt with the second aqueous solution comprising ammonium bicarbonate, ammonium carbonate, ammonia, ammonium carbamate, or combination thereof to form the wet composition comprising vaterite particles. This aspect is illustrated in FIG. 4B, wherein the gaseous stream comprising CO₂ and the gaseous stream comprising NH₃ from step A of the process are recirculated to the cooling reactor/reaction (step F) for the formation of the carbonate and bicarbonate solutions as shown in the reactions further herein below. The remaining steps of FIG. 4B are identical to the steps of FIGS. 2B and 3B.

It is to be understood that the aforementioned aspect illustrated in FIG. 4B may be combined with the aspects illustrated in FIG. 2B and/or FIG. 3B such that the precipitation step C comprises treating the first aqueous solution comprising calcium salt with the second aqueous solution comprising ammonium bicarbonate, ammonium carbonate, ammonia, ammonium carbamate, or combination thereof (illustrated in FIG. 4B), as well as comprises treating the aqueous solution comprising calcium salt with the gaseous stream comprising carbon dioxide (illustrated in FIG. 2B) and/or comprises treating the aqueous solution comprising calcium salt with the gaseous stream comprising carbon dioxide and the gaseous stream comprising ammonia (illustrated in FIG. 3B). In such embodiments, the gaseous stream comprising carbon dioxide is split between the stream going to the cooling process and the stream going to the precipitation process. Similarly, in such embodiments, the gaseous stream comprising ammonia is split between the stream going to the cooling process and the stream going to the precipitation process. Any combination of the processes depicted in FIGS. 2B, 3B, and 4B is possible and all are within the scope of this disclosure.

The ammonium carbamate has a formula NH₄[H₂NCO₂] consisting of ammonium ions NH₄⁺, and carbamate ions H₂NCO₂⁻.

The combination of these condensed products in the second aqueous solution may be dependent on one or more of the cooling conditions during the cooling step.

In some embodiments of the aforementioned aspect and embodiments, the gaseous stream (e.g., the gaseous streams going to the cooling reaction/reactor (step F in FIGS. 4A and 4B)) further comprises water vapor. In some embodiments of the aforementioned aspect and embodiments, the gaseous stream further comprises between about 20-90%; or between about 20-80%; or between about 20-70%; or between about 20-60%; or between about 20-55%; or between about 20-50%; or between about 20-40%; or between about 20-30%; or between about 20-25%; or between about 30-90%; or between about 30-80%; or between about 30-70%; or between about 30-60%; or between about 30-50%; or between about 30-40%; or between about 40-90%; or between about 40-80%; or between about 40-70%; or between about 40-60%; or between about 40-50%; or between about 50-90%; or between about 50-80%; or between about 50-70%; or between about 50-60%; or between about 60-90%; or between about 60-80%; or between about 60-70%; or between about 70-90%; or between about 70-80%; or between about 80-90%, water vapor.

Intermediate steps in the cooling reaction/reactor may include the formation of ammonium carbonate and/or ammonium bicarbonate and/or ammonium carbamate, by reactions as below:

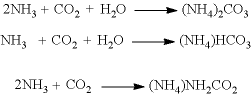

Similar reactions may be shown for the N-containing organic salt:

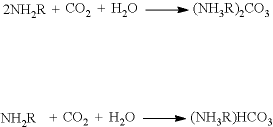

An advantage of cooling the ammonia in the cooling reaction/reactor is that ammonia may have a limited vapor pressure in the vapor phase of the dissolution reaction. By reacting the ammonia with CO₂, as shown in the reactions above, can remove some ammonia from the vapor space, allowing more ammonia to leave the dissolution solution.

The second aqueous solution comprising ammonium bicarbonate, ammonium carbonate, ammonia, ammonium carbamate, or combination thereof (exiting the cooling reaction/reactor in FIGS. 4A and 4B) is then treated with the first aqueous solution comprising calcium salt from the dissolution reaction/reactor, in the precipitation reaction/reactor (step C) to form the precipitation material comprising vaterite particles:

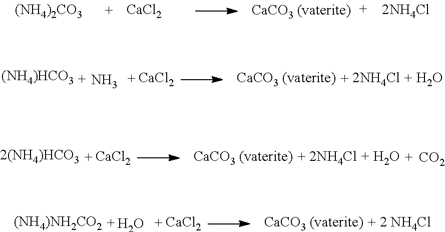

In some embodiments of the aspects and embodiments provided herein, the cooling step takes place under the one or more cooling conditions comprising temperature between about 0-200° C., or between about 0-150° C., or between about 0-75° C., or between about 0-100° C., or between about 0-80° C., or between about 0-60° C., or between about 0-50° C., or between about 0-40° C., or between about 0-30° C., or between about 0-20° C., or between about 0-10° C.

In some embodiments of the aspects and embodiments provided herein, the one or more cooling conditions comprise pressure between about 0.5-50 atm; or between about 0.5-25 atm; or between about 0.5-10 atm; or between about 0.1-10 atm; or between about 0.5-1.5 atm; or between about 0.3-3 atm.

In some embodiments, the formation and the quality of the vaterite particles formed in the methods and systems provided herein, is dependent on the amount and/or the ratio of the condensed products in the second aqueous solution comprising ammonium bicarbonate, ammonium carbonate, ammonia, ammonium carbamate, or combination thereof.

In some embodiments, the presence or absence or distribution of the condensed products in the second aqueous solution comprising ammonium bicarbonate, ammonium carbonate, ammonia, ammonium carbamate, or combination thereof, can be selected in order to maximize the formation of the vaterite particles and/or to obtain a desired particle size distribution. This selection can be based on the one or more cooling conditions, such as, pH of the aqueous solution in the cooling reactor, flow rate of the CO₂ and the NH₃ gases, and/or ratio of the CO₂:NH₃ gases. The inlets for the cooling reactor may be carbon dioxide (CO_{2(g)}), the dissolution reactor gas exhaust containing ammonia (NH_{3(g)}), water vapor, and optionally fresh makeup water (or some other dilute water stream). The outlet may be a slipstream of the reactor's recirculating fluid (the second aqueous solution), which is directed to the precipitation reactor for contacting with the aqueous solution and optionally additional carbon dioxide and/or ammonia. The pH of the system may be controlled by regulating the flow rate of CO₂ and NH₃ into the cooling reactor. The conductivity of the system may be controlled by addition of dilute makeup water to the cooling reactor. Volume may be maintained constant by using a level detector in the cooling reactor or its reservoir.

It is to be understood that while FIGS. 4A and 4B illustrate a separate cooling reaction/reactor, in some embodiments, the dissolution reaction/reactor may be integrated with the cooling reaction/reactor. For example, the dissolution reactor may be integrated with a condenser acting as a cooling reactor. Various configurations of the integrated reactor described above, are described in U.S. application Ser. No. 17/184,933, filed Feb. 25, 2021, which is incorporated herein by reference in its entirety.

In the aforementioned aspects, both the dissolution and the cooling reactors are fitted with inlets and outlets to receive the required gases and collect the aqueous streams. In some embodiments of the aforementioned aspect, the dissolution reactor comprises a stirrer to mix the lime or the limestone with the aqueous N-containing salt solution. The stirrer can also facilitate upward movement of the gases. In some embodiments of the aforementioned aspect, the dissolution reactor is configured to collect the solids settled at the bottom of the reactor after removing the first aqueous solution comprising calcium salt. In some embodiments of the aforementioned aspect, the cooling tower comprises one or more trays configured to catch and collect the condensed second aqueous solution and prevent it from falling back into the dissolution reactor. As such, the cooling/condensation may be accomplished through use of infusers, bubblers, fluidic Venturi reactors, spargers, gas filters, sprays, trays, or packed column reactors, and the like.

In some embodiments, the contacting of the aqueous solution comprising calcium salt with carbon dioxide and optionally ammonia or second aqueous solution is achieved by contacting the aqueous solution to achieve and maintain a desired pH range, a desired temperature range, and/or desired divalent cation concentration using a convenient protocol as described herein (precipitation conditions). In some embodiments, the systems include a precipitation reactor configured to contact the aqueous solution comprising calcium salt with carbon dioxide and optionally ammonia from step A of the process or the systems include a precipitation reactor configured to contact the first aqueous solution comprising calcium salt with the second aqueous solution comprising ammonium bicarbonate, ammonium carbonate, ammonia, ammonium carbamate, or combination thereof.

In some embodiments, the aqueous solution comprising calcium salt may be placed in a precipitation reactor, wherein the amount of the aqueous solution comprising calcium salt added is sufficient to raise the pH to a desired level (e.g., a pH that induces precipitation of the precipitation material) such as pH 7-9, pH 7-8.7, pH 7-8.5, pH 7-8, pH 7.5-8, pH 8-8.5, pH 8.5-9, pH 9-14, pH 10-14, pH 11-14, pH 12-14, or pH 13-14. In some embodiments, the pH of the aqueous solution comprising calcium salt when contacted with the carbon dioxide and optionally the NH₃ or the second aqueous solution, is maintained at between 7-9 or between 7-8.7 or between 7-8.5 or between 7.5-8.5 or between 7-8, or between 7.6-8.5, or between 8-8.5, or between 7.5-9.5 in order to form the vaterite particles.

The aqueous solution comprising calcium salt may be contacted with the gaseous stream comprising the CO₂ and optionally the NH₃ using any convenient protocol. The contact protocols of interest include, but not limited to, direct contacting protocols (e.g., bubbling the gases through the aqueous solution), concurrent contacting means (i.e., contact between unidirectional flowing gaseous and liquid phase streams), countercurrent means (i.e., contact between oppositely flowing gaseous and liquid phase streams), and the like. As such, contact may be accomplished through use of infusers, bubblers, fluidic Venturi reactors, spargers, gas filters, sprays, trays, or packed column reactors, and the like, in the precipitation reactor. In some embodiments, gas-liquid contact is accomplished by forming a liquid sheet of solution with a flat jet nozzle, wherein the gases and the liquid sheet move in countercurrent, co-current, or crosscurrent directions, or in any other suitable manner. In some embodiments, gas-liquid contact is accomplished by contacting liquid droplets of the solution having an average diameter of 500 micrometers or less, such as 100 micrometers or less, with the gas source.

Any number of the gas-liquid contacting protocols described herein may be utilized. Gas-liquid contact or the liquid-liquid contact is continued until the pH of the precipitation reaction mixture is optimum (various optimum pH values have been described herein to form the precipitation material comprising vaterite particles), after which the precipitation reaction mixture is allowed to stir. The rate at which the pH drops may be controlled by addition of more of the aqueous solution comprising calcium salt during gas-liquid contact or the liquid-liquid contact. In addition, additional aqueous solution may be added after sparging to raise the pH back to basic levels for precipitation of a portion or all the precipitation material. In any case, the precipitation material may be formed upon removing protons from certain species in the precipitation reaction mixture. The precipitation material comprising carbonates may then be separated and optionally, further processed.

The one or more precipitation conditions include those that modulate the environment of the precipitation reaction mixture to produce the desired precipitation material comprising vaterite particles. Such one or more precipitation conditions include, but not limited to, temperature, pH, pressure, ion ratio, precipitation rate, presence of additive, presence of ionic species, concentration of additive and ionic species, stirring, residence time, mixing rate, form of agitation such as ultrasonics, presence of seed crystal, catalyst, membrane, or substrate, dewatering, drying, ball milling, etc. In some embodiments, the average particle size of the vaterite particles may also depend on the one or more precipitation conditions used in the precipitation of the precipitation material.

For example, the temperature of the precipitation reaction may be raised to a point at which an amount suitable for precipitation of the desired precipitation material occurs. In such embodiments, the temperature of the precipitation reaction may be raised to a value, such as from 20° C. to 60° C., and including from 25° C. to 60° C.; or from 30° C. to 60° C.; or from 35° C. to 60° C.; or from 40° C. to 60° C.; or from 50° C. to 60° C.; or from 25° C. to 50° C.; or from 30° C. to 50° C.; or from 35° C. to 50° C.; or from 40° C. to 50° C.; or from 25° C. to 40° C.; or from 30° C. to 40° C.; or from 25° C. to 30° C. In some embodiments, the temperature of the precipitation reaction may be raised using energy generated from low or zero carbon dioxide emission sources (e.g., solar energy source, wind energy source, hydroelectric energy source, waste heat from the flue gases of the carbon emitter, etc.).

The pH of the precipitation reaction may also be raised to an amount suitable for the precipitation of the desired precipitation material. In such embodiments, the pH of the precipitation reaction may be raised to alkaline levels for precipitation. In some embodiments, the precipitation conditions required to form the precipitation material include pH higher than 7 or pH of 8 or pH of between 7.1-8.5 or pH of between 7.5-8 or between 7.5-8.5 or between 8-8.5 or between 8-9 or between 7.6-8.4, in order to form the precipitation material. The pH may be raised to pH 9 or higher, such as pH 10 or higher, including pH 11 or higher or pH 12.5 or higher.

Adjusting major ion ratios during precipitation may influence the nature of the precipitation material. Major ion ratios may have considerable influence on polymorph formation. For example, as the magnesium:calcium ratio in the water increases, aragonite may become the major polymorph of calcium carbonate in the precipitation material over low-magnesium vaterite. At low magnesium:calcium ratios, low-magnesium calcite may become the major polymorph. In some embodiments, where Ca²⁺ and Mg²⁺ are both present, the ratio of Ca²⁺ to Mg²⁺ (i.e., Ca²⁺:Mg²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000. In some embodiments, the ratio of Mg²⁺ to Ca²⁺ (i.e., Mg²⁺:Ca²⁺) in the precipitation material is 1:1 to 1:2.5; 1:2.5 to 1:5; 1:5 to 1:10; 1:10 to 1:25; 1:25 to 1:50; 1:50 to 1:100; 1:100 to 1:150; 1:150 to 1:200; 1:200 to 1:250; 1:250 to 1:500; or 1:500 to 1:1000.

In some embodiments, the one or more precipitation conditions to produce the desired precipitation material from the precipitation reaction may include, as above, the temperature and pH, as well as, in some instances, the concentrations of additives and ionic species in the water. The additives have been described herein. The presence of the additives and the concentration of the additives may also favor formation of the vaterite particles. In some embodiments, a middle chain or long chain fatty acid ester may be added to the aqueous solution during the precipitation to form the vaterite particles. Examples of fatty acid esters include, without limitation, cellulose such as carboxymethyl cellulose, sorbitol, citrate such as sodium or potassium citrate, stearate such as sodium or potassium stearate, phosphate such as sodium or potassium phosphate, sodium tripolyphosphate, hexametaphosphate, EDTA, or combinations thereof. In some embodiments, a combination of stearate and citrate may be added during the precipitation step of the process to form the vaterite particles.

In some embodiments, the gas leaving the precipitation reactor (shown as “scrubbed gas” in the figures) passes to a gas treatment unit for a scrubbing process. The mass balance and equipment design for the gas treatment unit may depend on the properties of the gases. In some embodiments, the gas treatment unit may incorporate an HCl scrubber for recovering the small amounts of NH₃ in the gas exhaust stream that may be carried from the CO₂ absorption, precipitation step by the gas. NH₃ may be captured by the HCl solution through:

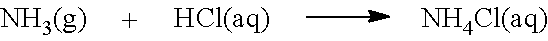

The NH₄Cl (aq) from the HCl scrubber may be recycled to the dissolution step A.

In some embodiments, the gas exhaust stream comprising ammonia (shown as “scrubbed gas” in the figures) may be subjected to a scrubbing process where the gas exhaust stream comprising ammonia is scrubbed with the carbon dioxide from the industrial process and water to produce a solution of ammonia. The inlets for the scrubber may be carbon dioxide (CO_{2(g)}), the reactor gas exhaust containing ammonia (NH_{3(g)}), and fresh makeup water (or some other dilute water stream). The outlet may be a slipstream of the scrubber's recirculating fluid (e.g. H₃N—CO_{2(aq)} or carbamate), which may optionally be returned back to the main reactor for contacting with carbon dioxide and precipitation. The pH of the system may be controlled by regulating the flow rate of CO_{2(g)} into the scrubber.

In some embodiments, the methods and systems provided herein further include separating the precipitation material comprising vaterite particles (step D in FIGS. 2A, 2B, 3A, 3B, 4A, and 4B) from the aqueous solution by dewatering to form vaterite particle cake or the wet composition comprising vaterite particles or slurry form of the vaterite particles. The wet composition comprising vaterite particles or the slurry comprising vaterite particles or the vaterite cake or the vaterite particle cake are used interchangeably herein. The vaterite cake may be subjected optionally to rinsing and then to transforming under the one or more transforming conditions (described herein) to partially transform the vaterite particle into the needle shaped aragonite particle (step E in FIGS. 2A, 2B, 3A, 3B, 4A, and 4B) to form the calcium carbonate polymorph composition. The calcium carbonate polymorph composition may be mixed optionally with other components such as, aluminosilicate material, SCM, e.g., limestone, Portland cement clinker, admixture, accelerator, additive, or mixture thereof, to form a blended composition.

The methods and systems provided herein may result in residual N-containing salt such as the residual N-containing inorganic or N-containing organic salt, e.g., residual ammonium salt remaining in the supernatant solution as well as in the precipitate itself after the formation of the precipitate. The residual base such as the N-containing inorganic or N-containing organic salt, e.g., residual ammonium salt (e.g., residual NH₄Cl) as used herein includes any salt that may be formed by ammonium ions and anions present in the solution including, but not limited to halogen ions such as chloride ions, nitrate or nitrite ions, and sulfur ions such as, sulfate ions, sulfite ions, thiosulfate ions, hydrosulfide ions, and the like. In some embodiments, the residual N-containing inorganic salt comprises ammonium acetate, ammonium halide, ammonium sulfate, ammonium sulfite, ammonium hydrosulfide, ammonium thiosulfate, ammonium nitrate, ammonium nitrite, or combination thereof. These residual salts may be removed and optionally recovered from the supernatant solution as well as the precipitate. In some embodiments, the supernatant solution further comprising the N-containing inorganic or N-containing organic salt, e.g., residual ammonium salt (e.g., residual NH₄Cl), is recycled back to the dissolution reactor for the dissolution of the lime or the limestone (to step A in FIGS. 2A, 2B, 3A, 3B, 4A, and 4B).

The calcium carbonate polymorph composition may be dried using any drying techniques known in the art such as, but not limited to fluid bed dryer or swirl fluidizer. Depending on the particular drying protocol of the system, the drying station may include a filtration element, freeze-drying structure, spray-drying structure, etc. In some embodiments, the precipitate may be dried by fluid bed dryer. In certain embodiments, waste heat from a power plant or similar operation may be used to perform the drying step when appropriate.

In the methods and systems provided herein, the separation or dewatering step D may be carried out on the separation station. The wet composition or the cake or the precipitate comprising vaterite particles may be stored in the supernatant for a period of time following precipitation and prior to separation. For example, the wet composition may be stored in the supernatant for a period of time ranging from few min to hours to 1 to 1000 days or longer, such as 1 to 10 days or longer, at a temperature ranging from 1° C. to 40° C., such as 20° C. to 25° C. Separation or dewatering may be achieved using any of a number of convenient approaches, including draining (e.g., gravitational sedimentation of the precipitate followed by draining), decanting, filtering (e.g., gravity filtration, vacuum filtration, filtration using forced air), centrifuging, pressing, or any combination thereof. Separation of the bulk water from the precipitate produces the wet cake of the composition comprising vaterite particles. Liquid-solid separator such as Epuramat's Extrem-Separator (“ExSep”) liquid-solid separator, Xerox PARC's spiral concentrator, or a modification of either of Epuramat's ExSep or Xerox PARC's spiral concentrator, may be useful for the separation of the wet composition comprising vaterite particles.

The methods and systems provided herein further comprise a control system configured to remotely and/or automatedly control the calcining reactor, the dissolution reactor, and/or the treatment reactor.

The methods and systems may also include one or more detectors configured for monitoring the systems producing the wet composition or the calcium carbonate polymorph composition. Monitoring may include, but is not limited to, collecting data about the pressure, temperature, humidity, and composition. The detectors may be any convenient device configured to monitor, for example, pressure sensors (e.g., electromagnetic pressure sensors, potentiometric pressure sensors, etc.), temperature sensors (resistance temperature detectors, thermocouples, gas thermometers, thermistors, pyrometers, infrared radiation sensors, etc.), volume sensors (e.g., geophysical diffraction tomography, X-ray tomography, hydroacoustic surveyers, etc.), and devices for determining chemical makeup of the composition (e.g, IR spectrometer, NMR spectrometer, UV-vis spectrophotometer, high performance liquid chromatographs, inductively coupled plasma emission spectrometers, inductively coupled plasma mass spectrometers, ion chromatographs, X-ray diffractometers, gas chromatographs, gas chromatography-mass spectrometers, flow-injection analysis, scintillation counters, acidimetric titration, and flame emission spectrometers, etc.).

In some embodiments, detectors may also include a computer interface which is configured to provide a user with the collected data about the composition. In some embodiments, the summary may be stored as a computer readable data file or may be printed out as a user readable document.

In some embodiments, the detector may be a monitoring device such that it can collect real-time data (e.g., internal pressure, temperature, etc.). In other embodiments, the detector may be one or more detectors configured to determine the parameters at regular intervals, e.g., determining the composition every 1 minute, every 5 minutes, every 10 minutes, every 30 minutes, every 60 minutes, every 100 minutes, every 200 minutes, every 500 minutes, or some other interval.

A control station may include a set of valves or multi-valve systems which are manually, mechanically, or digitally controlled, or may employ any other convenient flow regulator protocol. In some instances, the control station may include a computer interface, (where regulation is computer-assisted or is entirely controlled by computer) configured to provide a user with input and output parameters to control the production of the aggregates, as described above.

### II. Compositions

Disclosed herein are unique calcium carbonate polymorph compositions with unique morphology and characteristics, comprising vaterite particle and needle shaped aragonite particle, wherein the needle shaped aragonite particle is on the surface of the vaterite particle. Various characteristics of the calcium carbonate polymorph composition have been described herein including the characteristics, such as, but not limited to, the needle shaped aragonite particle accelerates transformation (e.g., by nucleation and enhancing growth kinetics) of the vaterite particle to the needle shaped aragonite particle when it comes into contact with water, and/or the needle shaped aragonite particle accelerates setting and hardening after transformation of the vaterite particle to the needle shaped aragonite particle when it comes into contact with water.

In one aspect, there are provided calcium carbonate polymorph compositions, comprising vaterite particle and needle shaped aragonite particle, wherein the needle shaped aragonite particle is on surface of the vaterite particle. In some embodiments of the above noted aspect, the vaterite particle is spherical shaped and the needle shaped aragonite particle is radiating out from the surface of the vaterite particle. This unique morphology of the carbonate polymorph composition drives the transformation of the vaterite particles to the needle shaped aragonite particle when the vaterite comes into contact with the water and undergoes the dissolution and the re-precipitation. The aragonite formed sets and hardens into cement with complex microstructure of the aragonite needles providing high compressive and flexural strength to the product.

In some embodiments, the calcium carbonate polymorph composition provided herein comprises between about 5-90% by weight of the needle shaped aragonite particle with the remaining being vaterite particle by weight. In some embodiments, the calcium carbonate polymorph composition comprises between about 5-90% by weight aragonite; or between about 10-90% by weight aragonite; or between about 10-80% by weight aragonite; or between about 10-70% by weight aragonite; or between about 10-60% by weight aragonite; or between about 10-50% by weight aragonite; or between about 10-40% by weight aragonite; or between about 10-30% by weight aragonite; or between about 10-20% by weight aragonite; or between about 20-90% by weight aragonite; or between about 30-90% by weight aragonite; or between about 40-90% by weight aragonite; or between about 50-90% by weight aragonite; or between about 60-90% by weight aragonite; or between about 70-90% by weight aragonite; or between about 20-50% by weight aragonite; or between about 30-50% by weight aragonite; or between about 70-90% by weight aragonite, with the remaining being vaterite particles by weight. In some embodiments, the calcium carbonate polymorph composition provided herein comprises between about 10% w/w to 95% w/w vaterite; or between about 50% w/w to 95% w/w vaterite; or between about 50% w/w to 75% w/w vaterite; or between about 60% w/w to 95% w/w vaterite; or between about 70% w/w to 95% w/w vaterite; or between about 80% w/w to 95% w/w vaterite, with the remaining % w/w being aragonite.

In some embodiments of the above noted aspect and embodiments, the vaterite particle and the needle shaped aragonite particle have an average particle size of between about 0.1-150 μm; or between about 0.1-100 μm; or between about 0.1-75 μm; or between about 0.1-50 μm; or between about 0.1-25 μm; or between about 0.1-20 μm; or between about 0.1-10 μm; or between about 5-100 μm; or between about 5-50 μm; or between about 5-20 μm; or between about 10-100 μm; or between about 10-50 μm; or between about 10-20 μm; or between about 25-100 μm; or between about 25-50 μm. It is to be understood that the average particle size of the vaterite particle and the aragonite particle in the composition may differ.

In some embodiments, the calcium carbonate polymorph composition provided herein comprises vaterite particles having an average particle size of between about 0.1-100 μm and the needle shaped aragonite particle on the surface of the vaterite particles having an average size of between about 0.1-50 μm, or between about 0.1-100 μm, or between about 0.1-150 μm.

The average particle size (or average particle diameter) may be determined using any conventional particle size determination method, such as, but not limited to, multi-detector laser scattering or laser diffraction or sieving. In certain embodiments, unimodal or multimodal, e.g., bimodal, trimodal or other, distributions of the vaterite particles and/or the aragonite particles are present. Bimodal distributions may allow the surface area to be minimized, thus allowing a lower liquids/solids mass ratio when composition is mixed with water yet providing smaller reactive particles for early reaction. In some embodiments, the vaterite particles includes two or more, or three or more, or four or more, or five or more, or ten or more, or 20 or more, or 3-20, or 4-10 different sizes of the particles in the composition. For example, the composition may include two or more, or three or more, or between 3-20 particles ranging from 0.1-50 micron, 0.1-20 micron, 10-50 micron, 50-100 micron, and/or sub-micron sizes of the vaterite particles.

In some embodiments of the above noted aspect and embodiments, the vaterite particle has a specific surface area of between about 100-40,000 m²/kg and the needle shaped aragonite particle has a specific surface area of between about 100-20,000 m²/kg.

In some embodiments of the above noted aspect and embodiments, the vaterite particle and the needle shaped aragonite particle have the specific surface area of between about 100-10,000 m²/kg; or between about 100-9,000 m²/kg; or between about 100-8,000 m²/kg; or between about 100-7,000 m²/kg; or between about 100-6,000 m²/kg; or between about 100-5,000 m²/kg; or between about 100-4,000 m²/kg; or between about 100-3,000 m²/kg; or between about 100-2,000 m²/kg; or between about 100-1,000 m²/kg; or between about 100-500 m²/kg.

In some embodiments, the calcium carbonate polymorph composition provided herein optionally comprises other one or more other components (to form a blend) selected from the group consisting of limestone, aluminosilicate material, aggregate (fine and/or coarse), slag from metal production, Portland cement clinker, calcium aluminate cement clinker, calcium sulfoaluminate cement clinker, supplementary cementitious material (SCM), carbonate material, alkali metal accelerator or an alkaline earth metal accelerator, admixture, additive, and combination thereof. In some embodiments, the aforementioned other components are added to the calcium carbonate polymorph composition. As used herein, “supplementary cementitious material” (SCM) includes SCM as is well known in the art. In some embodiments, the SCM comprises slag, fly ash, silica fume, or combination thereof. The aluminosilicate material includes any material that is rich in aluminate and silicate minerals. These materials can be natural or man-made. In some embodiments, the aluminosilicate material comprises heat-treated clay, e.g., calcined clay, natural or artificial pozzolan, shale, granulated blast furnace slag, or combination thereof. In some embodiments, the natural or artificial pozzolan is selected from the group consisting of fly ash, volcanic ash, or mixture thereof. Pozzolan may be naturally available and comprise very fine particles of siliceous and aluminous material that in presence of water may react with Ca ions in the vaterite to form cementitious material. In some embodiments, the heat-treated clay includes, but not limited to, calcined clay, aluminosilicate glass, calcium aluminosilicate glass, or combination thereof.

Various other components that can be blended in the composition, such as but not limited to, carbonate material, such as limestone or magnesium carbonate, alkali metal accelerator, or alkaline earth metal accelerator etc. The alkali metal or the alkaline earth metal accelerator includes, but not limited to any alkali metal or an alkaline earth metal salt, such as e.g., sodium sulfate, sodium carbonate, sodium nitrate, sodium nitrite, sodium hydroxide, potassium sulfate, potassium carbonate, potassium nitrate, potassium nitrite, lithium sulfate, lithium carbonate, lithium nitrate, lithium nitrite, lithium hydroxide, calcium sulfate (or gypsum), calcium nitrate, calcium nitrite, potassium hydroxide, and combination thereof.

In some embodiments, the calcium carbonate polymorph composition further comprises a magnesium and/or strontium cation. In some embodiments, the magnesium and/or strontium cation may facilitate the transformation of the vaterite into the needle shaped aragonite. In some embodiments, the magnesium and/or strontium cation may be present in the form of a salt including, but not limited to, magnesium and/or strontium halide, or magnesium and/or strontium sulfate, or magnesium and/or strontium nitrate etc. In some embodiments, the magnesium and/or strontium salt is selected from the group consisting of magnesium carbonate, magnesium halide, magnesium hydroxide, magnesium silicate, magnesium sulfate, magnesium nitrate, magnesium nitrite, strontium carbonate, strontium halide, strontium hydroxide, strontium silicate, strontium sulfate, strontium nitrate, strontium nitrite, and combination thereof. In some embodiments, the magnesium and/or strontium is present in range of between about 0.05-0.1 M.

In some embodiments, the calcium carbonate polymorph composition may further include one or more plasticizers. Examples of plasticizer include, without limitation, polycarboxylate based superplasticizers, MasterGlenium 7920, MasterGlenium 7500, Fritz-Pak Supercizer PCE, sodium salt of poly(naphthalene sulfonic acid), Fritz-Pak Supercizer 5, and the like.

In some embodiments, the calcium carbonate polymorph composition may further include one or more admixtures to impart one or more properties to the product including, but not limited to, strength, flexural strength, compressive strength, porosity, thermal conductivity, etc. The amount of admixture that is employed may vary depending on the nature of the admixture. In some embodiments, the amount of the one or more admixtures ranges from 0.1 to 10% w/w. Examples of the admixture include, but not limited to, set accelerator, set retarder, air-entraining agent, foaming agent, defoamer, alkali-reactivity reducer, bonding admixture, dispersant, coloring admixture, corrosion inhibitor, damp-proofing admixture, gas former, permeability reducer, pumping aid, shrinkage compensation admixture, fungicidal admixture, germicidal admixture, insecticidal admixture, rheology modifying agent, finely divided mineral admixture, pozzolan, aggregate, wetting agent, strength enhancing agent, water repellent, reinforcing material, or combination thereof, or any other admixture. When using an admixture, the composition to which the admixture raw material is introduced, is mixed for sufficient time to cause the admixture raw material to be dispersed relatively uniformly throughout the composition.

In some embodiments, the calcium carbonate polymorph composition may further include reinforcing material such as fiber, e.g., where fiber-reinforced product is desirable. Fiber can be made of zirconia containing materials, aluminum, glass, steel, carbon, ceramic, grass, bamboo, wood, fiberglass, or synthetic material, e.g., polypropylene, polycarbonate, polyvinyl chloride, polyvinyl alcohol, nylon, polyethylene, polyester, rayon, high-strength aramid, (i.e., Kevlar®), or mixture thereof.

In some embodiments, the mixer system configured to prepare the blended compositions is rotary mixer, static mixer, pin mixer, Hobart mixer, slant cylinder mixer, Omni Mixer, Henschel mixer, V-type mixer, or Nauta mixer. Such mixers are commercially known in the art.

In some embodiments, the calcium carbonate polymorph composition may include one or more additives. Some examples of inorganic additive or organic additive in the compositions provided herein, include, but not limited to, sodium decyl sulfate, lauric acid, sodium salt of lauric acid, urea, citric acid, sodium salt of citric acid, phthalic acid, sodium salt of phthalic acid, taurine, creatine, dextrose, poly(n-vinyl-1-pyrrolidone), aspartic acid, sodium salt of aspartic acid, magnesium chloride, acetic acid, sodium salt of acetic acid, glutamic acid, sodium salt of glutamic acid, strontium chloride, gypsum, lithium chloride, sodium chloride, glycine, sodium citrate dehydrate, sodium bicarbonate, magnesium sulfate, magnesium acetate, sodium polystyrene, sodium dodecylsulfonate, poly-vinyl alcohol, or combination thereof. In some embodiments, inorganic additive or organic additive in the compositions provided herein, include, but not limited to, taurine, creatine, poly(n-vinyl-1-pyrrolidone), lauric acid, sodium salt of lauric acid, urea, magnesium chloride, acetic acid, sodium salt of acetic acid, strontium chloride, magnesium sulfate, magnesium acetate, or combination thereof. In some embodiments, inorganic additive or organic additive in the compositions provided herein, include, but not limited to, magnesium chloride, magnesium sulfate, magnesium acetate, or combination thereof.

In one aspect, there are provided concrete mixes comprising any of the foregoing calcium carbonate polymorph compositions.

### III. Cement and Cementitious Products

In some embodiments, the compositions provided herein, such as e.g., the calcium carbonate polymorph composition, are used in making various types of materials used in construction. For example only, the compositions provided herein are utilized to produce lightweight concrete. Common cementitious applications for the compositions include, but not limited to, floor slab in high-rise building, concrete masonry unit, or any application where reduced weight of the concrete or the product is desired. In some embodiments, the compositions are used in agricultural applications as a soil additive to improve aeration and water retention or as a soilless growing media, such as used in certain hydroponic setups.

In some embodiments, the compositions provided herein, such as e.g., the calcium carbonate polymorph composition provided herein, are used in forming a building material. The “building material” used herein includes material used in construction. Examples of such structures or the building materials include, but are not limited to, building, driveway, foundation, kitchen slab, furniture, pavement, road, bridge, motorway, overpass, parking structure, brick, block, wall, footing for a gate, fence, pole, or module thereof.

In some embodiments, the compositions provided herein, such as e.g., the calcium carbonate polymorph composition provided herein, are used in forming formed building material. The “formed building material” used herein includes materials shaped into structures with defined physical shape. Examples of the formed building material that can be produced by the foregoing methods and systems, include, but not limited to, masonry unit, for example only, brick, block, and tile including, but not limited to, ceiling tile; construction panel, for example only, cement board and/or drywall; conduit; basins; beam; column, slab; acoustic barrier; insulation material; or combination thereof. Construction panels are formed building materials employed in a broad sense to refer to any non-load-bearing structural element that are characterized such that their length and width are substantially greater than their thickness. As such the panel may be a plank, a board, shingle, and/or tile.

In some embodiments, the cement board and/or the drywall may be used in making different types of boards such as, but not limited to, paper-faced board, fiberglass-faced or glass mat-faced board (e.g., surface reinforcement with glass fiber mat), fiberglass mesh reinforced board (e.g., surface reinforcement with glass mesh), and/or fiber-reinforced board (e.g., cement reinforcement with cellulose, glass, fiber etc.). These boards may be used in various applications including, but not limited to, siding such as, fiber-cement siding, roofing, soffit, sheathing, cladding, decking, ceiling, shaft liner, wall board, backer, trim, frieze, shingle, and fascia, and/or underlayment. The cement boards are formed building materials which in some embodiments, are used as backer boards for ceramics that may be employed behind bathroom tile, kitchen counter, backsplash, etc. and may have lengths ranging from 100 to 200 cm. Cement boards may vary in physical and mechanical properties. In some embodiments, the flexural strength may vary, ranging between 1 to 7.5 MPa, including 2 to 6 MPa, such as 5 MPa. The compressive strengths may also vary, ranging from 5 to 50 MPa, including 10 to 30 MPa, such as 15 to 20 MPa. In some embodiments, cement boards may be employed in environments having extensive exposure to moisture (e.g., commercial saunas).

Another type of construction panel is backer board. The backer board may be used for the construction of interior, and/or exterior floor, wall, and ceiling. Another type of construction panel is drywall. The drywall includes board that is used for construction of interior, and/or exterior floor, wall, and ceiling. One of the applications of the cement board or drywall is fiber cement siding.

In some embodiments, the formed building material is masonry unit. Masonry unit is formed building material used in the construction of load-bearing and non-load-bearing structures that are generally assembled using mortar, grout, and the like. Exemplary masonry unit formed from the 3D printing includes brick, block, and tile.

Another formed building material is a conduit. Conduits are tubes or analogous structures configured to convey a gas or liquid, from one location to another. Conduits can include any number of different structures used in the conveyance of a liquid or gas that include, but are not limited to, pipe, culvert, box culvert, drainage channel and portal, inlet structure, intake tower, gate well, outlet structure, and the like.

Another formed building material is basin. The term basin may include any configured container used to hold a liquid, such as water. As such, a basin may include, but is not limited to structures such as well, collection box, sanitary manhole, septic tank, catch basin, grease trap/separator, storm drain collection reservoir, etc.

Another formed building material is a beam, which, in a broad sense, refers to a horizontal load-bearing structure possessing large flexural and compressive strength. Beam may be rectangular cross-shaped, C-channel, L-section edge beam, I-beam, spandrel beam, H-beam, possess an inverted T-design, etc. Beam may also be horizontal load-bearing unit, which includes, but is not limited to joist, lintel, archway, and cantilever.

Another formed building material is a column, which, in a broad sense, refers to a vertical load-bearing structure that carries load chiefly through axial compression and includes structural element such as compression member. Other vertical compression member may include, but are not limited to pillar, pier, pedestal, or post.

Another formed building material is a concrete slab. Concrete slabs are those building materials used in the construction of prefabricated foundations, floors, and wall panels. In some instances, a concrete slab may be employed as a floor unit (e.g., hollow plank unit or double tee design).

Another formed building material is an acoustic barrier, which refers to a structure used as a barrier for the attenuation or absorption of sound. As such, an acoustic barrier may include, but is not limited to, structures such as acoustical panels, reflective barriers, absorptive barriers, reactive barriers, etc.

Another formed building material is an insulation material, which refers to a material used to attenuate or inhibit the conduction of heat. Insulation may also include those materials that reduce or inhibit radiant transmission of heat.

In some embodiments, the other formed building materials such as pre-cast concrete products include, but not limited to, bunker silo; cattle feed bunk; cattle grid; agricultural fencing; H-bunks; J-bunks; livestock slats; livestock watering troughs; architectural panel walls; cladding (brick); building trim; foundation; floors, including slab on grade; walls; double wall precast sandwich panel; aqueducts; mechanically stabilized earth panels; box culverts; 3-sided culverts; bridge systems; RR crossings; RR ties; sound walls/barriers; Jersey barriers; tunnel segments; reinforced concrete box; utility protection structure; hand holes; hollow core product; light pole base; meter box; panel vault; pull box; telecom structure; transformer pad; transformer vault; trench; utility vault; utility pole; controlled environment vaults; underground vault; mausoleum; grave stone; coffin; Haz mat storage container; detention vaults; catch basins; manholes; aeration system; distribution box; dosing tank; dry well; grease interceptor; leaching pit; sand-oil/oil-water interceptor; septic tank; water/sewage storage tank; wet wells; fire cisterns; floating dock; underwater infrastructure; decking; railing; sea walls; roofing tiles; pavers; community retaining wall; res. retaining wall; modular block systems; and segmental retaining walls.

In some embodiments, the methods and systems described herein include making artificial marine structures containing the compositions described herein including, but not limited to, artificial coral and reef. In some embodiments, the artificial structure can be used in aquarium or sea. In some embodiments, the aragonitic cement provides neutral or close to neutral pH which may be conducive for maintenance and growth of marine life. The aragonitic reef may provide suitable habitat for marine species.

Throughout the description, where compositions are described as having, including, or comprising specific components, or where processes and methods are described as having, including, or comprising specific steps, it is contemplated that, additionally, there are compositions of the present invention that consist essentially of, or consist of, the recited components, and that there are processes and methods according to the present invention that consist essentially of, or consist of, the recited processing steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a process described herein can be combined in a variety of ways without departing from the spirit and scope of the present invention, whether explicit or implicit herein. For example, where reference is made to a particular composition, that composition can be used in various embodiments of compositions of the present invention and/or in processes of the present invention, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of any and all examples, or exemplary language herein, for example, “such as” or “including,” is intended merely to illustrate better the present invention and does not pose a limitation on the scope of the invention unless claimed. No language in the specification should be construed as indicating any non-claimed element as essential to the practice of the present invention.

Certain ranges are presented herein with numerical values being preceded by the term “about.” The term “about” is used herein to provide literal support for the exact number that it precedes, as well as a number that is near to or approximately the number that the term precedes. As used herein, the term “about” refers to a ±10% variation from the nominal value unless otherwise indicated or inferred.

Unless defined otherwise, all technical and scientific terms used herein have the same meaning as commonly understood by one of ordinary skill in the art to which this invention belongs. Although any processes and materials similar or equivalent to those described herein can also be used in the practice or testing of the invention, representative illustrative processes and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It should be understood that the expression “at least one of”′ includes individually each of the recited objects after the expression and the various combinations of two or more of the recited objects unless otherwise understood from the context and use. The expression “and/or” in connection with three or more recited objects should be understood to have the same meaning unless otherwise understood from the context.

It is noted that, as used herein and in the appended claims, the singular forms “a”, “an”, and “the” include plural references unless the context clearly dictates otherwise. For example, where the plural form is used for compounds, salts, and the like, this is taken to mean also a single compound, salt, or the like. It is further noted that the claims may be drafted to exclude any optional element.

As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited process can be carried out in the order of events recited or in any other order, which is logically possible. It should be understood that the order of steps or order for performing certain actions is immaterial so long as the present invention remain operable. Moreover, two or more steps or actions may be conducted simultaneously.

The following examples are put forth to provide those of ordinary skill in the art with a complete disclosure and description of how to make and use the invention and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

In the examples and elsewhere, abbreviations have the following meanings:

| | | |
|---|---|---|
| g | = | gram |
| hr | = | hour |
| kg | = | kilogram |
| L | = | liter |
| lpm | = | liters per minute |
| M | = | molar |
| m²/kg | = | meter square per kilogram |
| mg | = | milligram |
| min | = | minute |
| mL/min | = | milliliter per minute |
| μm | = | micrometer or micron |
| mL | = | milliliter |
| wt % | = | weight percent |

### EXAMPLES

### Example 1

### Conversion of the Vaterite Particles to the Needle Shaped Aragonite Particles

In this experiment, 5.97 kg (kilogram) of NH₄Cl (ammonium chloride) and 2.78 kg of CaO (calcium oxide) were added to 53.43 kg of pure water to produce 60 L (liter) of feed solution with concentrations of 1.86 M (molar) NH₄Cl and 0.78 M CaO. Feed solution was allowed to mix until all solutes were dissolved. Insoluble impurities were not filtered out.

Using a peristaltic pump, feed was pumped through a water bath to heat the solution to 27° C. and into a 6.0 L reactor up to the outlet. Solution in the reactor was mixed at 1400 RPM (revolutions per minute) using a double Rushton impeller. Once the reactor was full to the outlet, feed flow was terminated, and gas flow was initiated. A mixture of 20% CO₂ and 80% compressed air was sparged into the reactor to drop the pH of the solution from 9.63 to 8.10. Once the target pH of 8.10 was reached, feed flow was resumed. Feed was pumped into the reactor at an average rate of 261 mL/min (milliliter/minute) and reactor temperature was maintained at 38° C. Vaterite slurry forming in the reactor due to the carbonation of the feed solution was pumped out of the reactor using a peristaltic pump. 6.0 L of the vaterite slurry was collected in a secondary collection vessel every 23 minutes and filtered using a tabletop vacuum filtration set up using cellulose filter paper. Post-filtration, the vaterite material was rinsed with 6.0 L of pure water. After rinsing, the vaterite material was dried at 150° C. until it was dry enough to be removed from the filter paper, after which it was dried at 330° C. (transforming conditions). The vaterite material was dried for >20 minutes in the oven at 150° C.

After the vaterite material was dried it was analyzed via XRD (X-ray diffraction) and PSA (particle size analysis) to quantify vaterite purity and particle size. The analysis showed 85.2% vaterite, 9.9% aragonite and 4.9% calcite with the needle shaped aragonite grown on the surface of the spherical vaterite.

### Example 2

### Conversion of the Vaterite Particles to the Needle Shaped Aragonite Particles

In this experiment, 5.97 kg of NH₄Cl and 2.73 kg of CaO were added to 53.43 kg of pure water to produce 60 L of feed solution with concentrations of 1.86 M NH₄Cl and 0.77 M CaO. Feed solution was allowed to mix until all solutes were dissolved. Insoluble impurities were not filtered out.

Using a peristaltic pump, feed was pumped through a water bath to heat the solution to 31° C. and into a 2.4 L reactor up to the outlet. Solution in the reactor was mixed at 1900 RPM using a double Rushton impeller. Once the reactor was full to the outlet, feed flow was terminated, and gas flow was initiated. A mixture of 20% CO₂ and 80% compressed air was sparged into the reactor to drop the pH of the solution from 9.74 to 8.10. Gas flow rates for CO₂ and compressed air were 2.0 and 7.2 lpm, respectively. Once the target pH of 8.10 was reached, feed flow was resumed. Feed was pumped into the reactor at an average rate of 103 mL/min and reactor temperature was maintained at 45° C. for the first two-thirds of the reactor run. To maintain a pH of ~8, gas flow rates were decreased to 1.8 and 6.7 lpm for CO₂ and compressed air respectively. During the last third of the run, reactor temperature was elevated to >48° C. To maintain pH and residence time, gas flow rates were decreased to 1.48 and 5.6 lpm for CO₂ and compressed air respectively.

Vaterite slurry forming in the reactor due to the carbonation of the feed solution was pumped out of the reactor using a peristaltic pump. 2.0 L of the vaterite slurry was collected in a secondary collection vessel every 20 minutes and filtered using a tabletop vacuum filtration set up using cellulose filter paper. Post-filtration, the vaterite material was rinsed with 2.0 L of pure water. After rinsing, the vaterite material was dried at 200° C. until it was dry enough to be removed from the filter paper, after which it was dried at 330° C. (transforming conditions). After the vaterite material was dried it was analyzed via XRD and PSA to quantify vaterite purity and particle size.

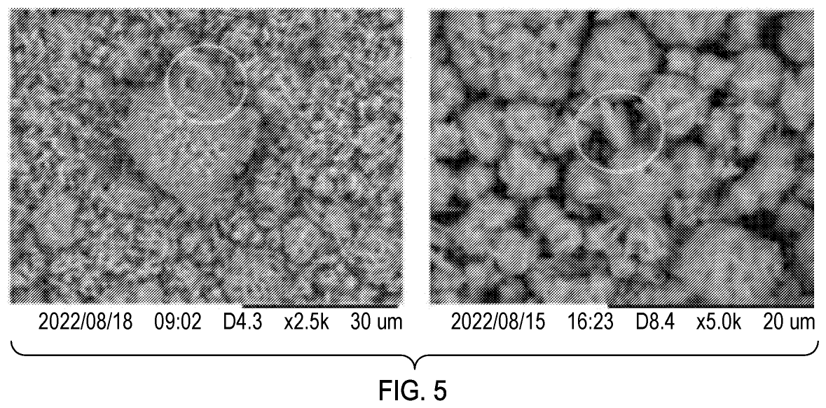

Initial carbonate produced at 45° C. was characterized as 95-97% vaterite. The vaterite content was observed to decrease as the run progressed at 45° C., with the aragonite content increasing in conjunction. The aragonite content increased to as high as 20.1% in the vaterite material. The reactor temperature was raised to >48° C. for the last third of the run. The vaterite material further increased in aragonite content relative to the material precipitated at 45° C., up to 92.4% aragonite. FIG. 5 shows the scanning electron microscope (SEM) images of the vaterite material with the needle shaped aragonite particle growing on the surface of the spherical vaterite particle.

Although the foregoing invention has been described in some detail by way of illustration and example for purposes of clarity of understanding, it should be readily apparent to those of ordinary skill in the art in light of the teachings of this invention that certain changes and modifications may be made thereto without departing from the scope of the appended claims. Accordingly, the preceding merely illustrates the principles of the invention. It will be appreciated that those skilled in the art will be able to devise various arrangements, which, although not explicitly described or shown herein, embody the principles of the invention, and are included within its scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein. It is intended that the following claims define the scope of the invention and that methods and structures within the scope of these claims and their equivalents be covered thereby.

1. A calcium carbonate polymorph composition, comprising: vaterite particles and aragonite particles, wherein the aragonite particles are formed on the surface of the vaterite particles.

2. The calcium carbonate polymorph composition of claim 1, wherein the vaterite particles are significantly spherical.

3. The calcium carbonate polymorph composition of claim 1, wherein the aragonite particles radiate out from the surface of the vaterite particles.

4. The calcium carbonate polymorph composition of claim 1, wherein the vaterite particles and the aragonite particles have an average particle size of between 0.1-150 mm.

5. The calcium carbonate polymorph composition of claim 1, the aragonite particles are between 5-90% by weight of the calcium carbonate polymorph composition.

6. The calcium carbonate polymorph composition of claim 1, wherein the aragonite particles accelerate transformation of the vaterite particles to more aragonite particle when coming into contact with water.

7. The calcium carbonate polymorph composition of claim 1, wherein the aragonite particles accelerate setting and hardening of the calcium carbonate polymorph composition.

8. The calcium carbonate polymorph composition of claim 1, wherein the vaterite particles have a specific surface area of between 200-40,000 m²/kg and the aragonite particles have a specific surface area of between 200-20,000 m²/kg.

9. The calcium carbonate polymorph composition of claim 1, further comprising calcite particles which are less than 5% by weight of the calcium carbonate polymorph composition.

10. The calcium carbonate polymorph composition of claim 1, wherein the composition further comprises one or more other components selected from a group consisting of limestone, aluminosilicate material, aggregate, slag from metal production, Portland cement clinker, calcium aluminate cement clinker, calcium sulfoaluminate cement clinker, carbonate material, alkali metal accelerator, an alkaline earth metal accelerator, admixture, additive, SCM, and combination thereof.

11. A method of producing a calcium carbonate polymorph composition, comprising:
forming a wet composition comprising vaterite particles;
transforming the wet composition comprising vaterite particles under one or more transforming conditions to partially transform the vaterite particles into aragonite particles, wherein the aragonite particles are formed on the surface of the vaterite particle; and
terminating the transformation of the vaterite particles into the aragonite particles to form a calcium carbonate polymorph composition comprising vaterite particles and aragonite particles.

12. The method of claim 11, wherein the transforming is under one or more transforming conditions comprising temperature between about 50-400° C., duration between about 10 min-1 hr, and/or relative humidity between about 60%-100%.

13. The method of claim 11, wherein the one or more transforming conditions partially transform the vaterite particles to the aragonite particles such that the calcium carbonate polymorph composition comprises between about 5-90% by weight of the aragonite particles.

14. The method of claim 12, wherein the termination of the transformation comprises removing the one or more the transforming conditions.

15. The method of claim 11, further comprising adding water to the calcium carbonate polymorph composition and transforming the vaterite particles to at least one of the aragonite particles and calcite particles upon dissolution and re-precipitation in water.

16. The method of claim 15, further comprising setting and hardening of at least one of the aragonite particles and calcite particles, and thereby forming a product.

17. The method of claim 11, wherein the aragonite particles accelerate further transformation of the vaterite particles to the aragonite particles when it comes into contact with water thereby accelerates setting and hardening of the calcium carbonate polymorph composition.

18. The method of claim 17, wherein the aragonite particles being on the surface of the vaterite particles accelerate transformation of the vaterite particles compared to aragonite particles when physically blended with the vaterite particles.

19. The method of claim 11, further comprising:
calcining limestone to form a mixture comprising lime and a gaseous stream comprising carbon dioxide;
dissolving the mixture comprising lime in a device may include a calcium carbonate polymorph composition, comprising: vaterite particles and aragonite particles, wherein the aragonite particles are formed on the surface of the vaterite particles. N-containing salt solution to produce an aqueous solution comprising calcium salt; and
treating the aqueous solution comprising calcium salt with the gaseous stream comprising carbon dioxide to form a wet composition comprising precipitated calcium carbonate particles.

20. The method of claim 11, further comprising:
dissolving limestone in an N-containing salt solution to produce an aqueous solution comprising calcium salt, and a gaseous stream comprising carbon dioxide; and
treating the aqueous solution comprising calcium salt with the gaseous stream comprising carbon dioxide to form the wet composition comprising precipitated calcium carbonate particles.

21. (canceled)

22. (canceled)
